(19) United States
(12) Patent Application Publication
(10) Pub. No.: US 2025/0372330 A1
(43) Pub. Date: Dec. 4, 2025

(54) CIRCUIT BREAKER AND OPERATING MECHANISM THEREOF

(71) Applicant: Chint Low Voltage Electrical Technology Co., Ltd., Songjiang District, Shanghai (CN)

(72) Inventors: Denggui AO, Songjiang District, Shanghai (CN); Dengyu LU, Songjiang District, Shanghai (CN); Yongfu XU, Songjiang District, Shanghai (CN); Lijun YAN, Songjiang District, Shanghai (CN); Xiaoqin YUAN, Songjiang District, Shanghai (CN); Xinyang ZHANG, Songjiang District, Shanghai (CN); Ya YUAN, Songjiang District, Shanghai (CN)

(21) Appl. No.: 18/877,840

(22) PCT Filed: Oct. 14, 2023
(86) PCT No.: PCT/CN2023/124631

§ 371 Date: Dec. 20, 2024

(30) Foreign Application Priority Data
Oct. 20, 2022 (CN) 202211283677.1

(51) Int. Cl. H01H 71/10; H01H 71/02; H01H 71/40; H01H 71/52

(52) U.S. Cl. CPC H01H 71/1009; H01H 71/0221; H01H 71/40; H01H 71/525

(57) ABSTRACT

The present invention relates to the field of low-voltage electrical appliances, and more particularly to an operating mechanism of a circuit breaker. The operating mechanism is provided with two sets of four-link structures. Each set of four-link structures is composed of a second crank, a third link and a third crank. The third crank and the phase-pole rotating shaft have the same rotation center and are in driving connection with each other. The other set of four-link structures is composed of a second crank, a fourth link and an N-pole rotating shaft, so that the phase-pole rotating shaft and the N-pole rotating shaft can be arranged around different rotation centers, so as to provide more convenience for the design of the circuit breaker.

### TECHNICAL FIELD

The present invention relates to the field of low-voltage electrical appliances, and more particularly to an operating mechanism of a circuit breaker and a circuit breaker including the operating mechanism of the circuit breaker.

### BACKGROUND

With the continuous development of photovoltaic technologies, the performance requirements of a power distribution system for a molded case circuit breaker have gradually increased, and current molded case circuit breaker products continue to develop in the direction of small volumes and high performances.

In order to meet high-voltage breaking requirements of two poles DC1000V and DC1500V of a molded case circuit breaker in a photovoltaic distribution line, it is a common design method to increase an arc voltage of an arc-extinguishing chamber, while traditional 250A molded case circuit breakers have the following problems, which affect the increase of the arc voltage of the arc-extinguishing chamber:
1. an operating mechanism is four-link or five-link conversion structure, and a rotation center of the operating mechanism and a rotation center of a rotating shaft mechanism are arranged side by side along the vertical direction of the operating mechanism, which makes the arc-extinguishing chamber or an arc-extinguishing system only be located on the left and right sides of the rotating shaft system. The volume of the arc-extinguishing chamber is difficult to increase significantly due to the limitation of an overall size of the product and fails to accommodate more arc-extinguishing grids to improve the heat capacity;
2. due to high correlation between links of the operating mechanism, it is not convenient to increase an opening distance between a moving contact and a static contact by adjusting a mating size between the links under the premise of satisfying other parameters;
3. the structural design of the arc-extinguishing chamber has poor arc-extinguishing performance; and
4. the arc-extinguishing chamber lacks a necessary auxiliary structure to accelerate an electric arc into the arc-extinguishing chamber.

### SUMMARY

An objective of the present invention is to overcome the defects of the prior art and provide an operating mechanism of a circuit breaker, which allows a phase-pole shaft mechanism and an N-pole rotating shaft mechanism to rotate around different rotation centers.

An operating mechanism of a circuit breaker, comprising a support, and a rocker arm assembly and a jump buckle, a lock buckle in buckling fit with the jump buckle, a re-buckle in limiting fit with the lock buckle which are rotatably arranged on the support respectively, a first crank, an energy storage spring, a slide rail fixedly arranged relative to the support, a slider arranged on the slide rail and sliding back and forth along its extension direction, and a first link; wherein one end of the first crank is rotatably arranged on the jump buckle around an eighth center, and another end of the first crank is rotatably connected to one end of the first link and one end of the energy storage spring around an eighteenth center; another end of the first link is rotatably connected to the slider, and another end of the energy storage spring is rotatably connected to the rocker arm assembly; and

the operating mechanism further comprises a phase-pole rotating shaft, an N-pole rotating shaft rotatably arranged around a twenty-second center, a second link, a second crank rotatably arranged around a sixth center, a third link, a third crank and a fourth link, wherein the phase-pole rotating shaft and the third crank are rotatably arranged around a seventh center respectively; one end of the second link is rotatably connected to the slider, and another end of the second link is rotatably connected to the second crank around a nineteenth center to drive the second crank to rotate; one end of the fourth link is rotatably connected to the second crank, and another end of the fourth link is rotatably connected to the N-pole rotating shaft to drive the N-pole rotating shaft to rotate; one end of the third link is rotatably connected to the second crank around the nineteenth center, and another end of the third link is rotatably connected to the third crank to drive the third crank to rotate; and the third crank is in driving connection with the phase-pole rotating shaft to drive the phase-pole rotating shaft to rotate.

Preferably, in a vertical direction of the operating mechanism, the rocker arm assembly and the second crank are respectively located at both ends of the operating mechanism, the phase-pole rotating shaft and the N-pole rotating shaft are arranged side by side, the third crank and the phase-pole rotating shaft are arranged close to the rocker arm assembly, and the N-pole rotating shaft is arranged close to the second crank; and

in a horizontal direction of the operating mechanism, the rocker arm assembly and the third crank are arranged side by side, and the third crank, the phase-pole rotating shaft and the N-pole rotating shaft are located on the same side of the operating mechanism.

Preferably, the rocker arm assembly is rotatably arranged on the support around a fourth center, and the fourth center, the seventh center, the twenty-second center and the sixth center are sequentially positioned at four vertices of a quadrilateral;
the third link is rotatably connected to the third crank around a twentieth center, and the sixth center, the seventh center, the twentieth center and the nineteenth center are sequentially located at four vertices of a quadrilateral; and
the fourth link is rotatably connected to the N-pole rotating shaft around a twenty-third center, and the sixth center, the twenty-second center, the twenty-third center and the twenty-first center are sequentially located at four vertices of a quadrilateral.

Preferably, the second crank and the third crank are rotatably arranged on the support around the sixth center and seventh center respectively.

Preferably, the support is provided with a third crank guide hole, the third link is rotatably connected with the third crank through the twentieth shaft, the twentieth shaft is inserted into the third crank guide hole, and a shape of the third crank guide hole is matched with a moving trajectory of the twentieth shaft.

Preferably, the second crank, the third crank, the N-pole rotating shaft and the phase-pole rotating shaft are arranged to rotate synchronously in the same direction.

Preferably, the second crank is of a triangular-shaped plate structure, wherein a first apex angle is rotatably arranged around the sixth center, a second apex angle is rotatably connected to the second link and the third link around the nineteenth center respectively, and a third apex angle is rotatably connected to the fourth link around the twenty-first center.

Preferably, the third crank is of a triangular-shaped plate structure, wherein a first apex angle is rotatably arranged around the seventh center, a second apex angle is rotatably connected to the third link around the twentieth center, and a third apex angle is rotatably connected to the phase-pole rotating shaft around a twenty-fourth center.

Preferably, the support comprises two support side plates that are oppositely arranged; each support side plate comprises a first side plate portion and a second side plate portion which are connected to each other; in a horizontal direction of the operating mechanism, the first side plate portion and the second side plate portion are arranged side by side; the rocker arm assembly, the jump buckle, the lock buckle, the re-buckle and the second crank are rotatably arranged on the first side plate portion respectively; a V-shaped groove and a slide rail are respectively arranged at both ends of the first side plate portion in a vertical direction of the operating mechanism; the rocker arm assembly is arranged to swing in the V-shaped groove; and the third crank is rotatably arranged on the second side plate portion.

Preferably, the operating mechanism comprises two sets of second cranks which are symmetrically arranged, two sets of third links which are symmetrically arranged, two sets of third cranks which are symmetrically arranged, two sets of fourth links which are symmetrically arranged, two sets of sliders which are symmetrically arranged, two sets of first links which are symmetrically arranged, two sets of first cranks which are symmetrically arranged, two sets of energy storage springs which are symmetrically arranged, and two sets of slide rails which are symmetrically arranged on the two support side plates; the rocker arm assembly comprises a handle and a rocker arm which are connected fixedly; the rocker arm comprises two rocker arm legs which are arranged oppositely, and the two rocker arm legs are rotatably arranged in the V-shaped grooves of the two support side plates through a fourth shaft respectively; the two sets of first cranks are respectively arranged on both sides of the jump buckle, and one ends of the two sets of first cranks are rotatably connected to the jump buckle through an eighth shaft; an axis of the eighth shaft coincides with the eighth center; the other ends of the two sets of first cranks, one ends of the two sets of first links and one ends of two sets of energy storage springs are connected rotatably through an eighteenth shaft; an axis of the eighteenth shaft coincides with the eighteenth center; another ends of the two sets of energy storage springs are connected to a energy storage spring shaft; the energy storage spring shaft is fixedly connected to the two rocker arm legs of the rocker arm respectively; the two sets of sliders are connected through a slider shaft and are respectively arranged on the two sets of slide rails; the other ends of the two sets of first links and one ends of the two sets of second links are rotatably connected to the two sets of sliders through the slider shaft respectively; the two sets of second cranks are rotatably arranged on the two support side plates through a sixth shaft respectively; another ends of two sets of second links and one ends of the two sets of third links are rotatably connected to the two sets of second cranks through a nineteenth shaft respectively; an axis of the nineteenth shaft coincides with the nineteenth center; the two sets of third cranks are rotatably arranged on the two support side plates through a seventh shaft; an axis of the seventh shaft coincides with the seventh center; another ends of the two sets of third links are rotatably connected to the two sets of third cranks through a twentieth shaft; an axis of the twentieth shaft coincides with the twentieth center; the two sets of third cranks are respectively in driving connection with the phase-pole rotating shaft through a phase-pole driving shaft; one ends of the two sets of fourth links are rotatably connected to the two sets of second cranks respectively through a twenty-first shaft, and another ends of the two sets of fourth links are rotatably connected to the N-pole rotating shaft respectively through an N-pole driving shaft; an axis of the twenty-first shaft coincides with the twenty-first center; and the two sets of fourth links are preferably located on two axial sides of the N-pole rotating shaft.

Preferably, when the operating mechanism is in an opened state or a tripped state, the slider is in limiting fit with the slide rail to prevent the slider from sliding, and the slider blocks the first crank from rotating through the first link.

Preferably, each slide rail is of a groove-like structure or a hole-like structure.

Preferably, the slide rail is arranged on the support.

Preferably, the operating mechanism further comprising a first draw bar and a transmission jump buckle that are in buckling fit with each other and rotatably arranged respectively, wherein when a short-circuit and/or overload fault occurs in a circuit where the circuit breaker is located, the first draw bar is driven by an external structure to rotate and releases buckling fit from the transmission jump buckle, and the transmission jump buckle rotates to drive the operating mechanism to trip.

Preferably, the operating mechanism further comprising a thermomagnetic tripping mechanism, wherein the thermomagnetic tripping mechanism serves as an external structure of the first draw bar; and when a short-circuit and an overload fault occurs in the circuit where the phase-pole breaking unit is located, the first draw bar is driven to rotate and releases buckling fit from the transmission jump buckle.

Preferably, when the operating mechanism is re-buckled from the tripped-opened state, the rocker arm assembly drives the transmission jump buckle to reset and restore buckling fit with the first draw bar.

Preferably, the first draw bar is rotatably arranged on the support around the fifth center, the transmission jump buckle is rotatably arranged on the support around the seventh center, and the first draw bar and the transmission jump buckle are both located between the two support side plates of the support.

The operating mechanism of the circuit breaker in the present invention implements respective driving of the N-pole rotating shaft and the phase-pole rotating shaft by arranging two sets of four-link structures, and allows rotation centers of the N-pole rotating shaft and the phase-pole rotating shaft to be different, providing higher flexibility for the design of the operating mechanism and the layout of the circuit breaker.

Furthermore, the slider converts a movement position of the first link in the opening and closing processes of the operating mechanism into a displacement of the slider, which is conducive to the actual measurement and the adjustment of parameters such as a size of a structure connected to the slider. In addition, the rotation of the mechanism links and the transfer of a torque can be implemented by the first crank, the first link and the slider, and the operating mechanism can implement the opening, closing and tripping operations without the connection to the phase-pole rotating shaft and/or N-pole rotating shaft, which is convenient for the modular production of the operating mechanism. That is, in the operating mechanism, the slide rail provides a guiding function for the slider, and also serve as a supporting point to provide a supporting force for the first link and the slider, so that the operating mechanism may have the stable closing position, opening position and tripping position without the connection to the rotating shaft mechanism of the breaking unit, making the operating mechanism become an independently operable component, which is conducive to the modular assembly and production of the operating mechanism. and provides more design space for the distribution of the operating mechanism in the circuit breaker. In addition, in actual production, the operating mechanism does not need to cooperate with a rotating shaft mechanism of the breaking unit, which avoids the loss of the contact system of the breaking unit during the test process and reduces R&D and production costs.

### BRIEF DESCRIPTION OF THE DRAWINGS

FIG. 1 is a schematic structural diagram of a circuit breaker in the present invention, showing an assembly relationship between various breaking units and a circuit breaker outer housing;

FIG. 2 is a schematic diagram of an assembly structure of an operating mechanism and an N-pole breaking unit in the present invention;

FIG. 3 is a schematic exploded view of the operating mechanism in the present invention;

FIG. 4a is a schematic structural diagram of the circuit breaker in a tripped state in the present invention;

FIG. 4b is a schematic structural diagram of the operating mechanism in the tripped state in the present invention;

FIG. 4c is a schematic diagram of a principle of the operating mechanism in the tripped state in the present invention;

FIG. 5a is a schematic structural diagram of the circuit breaker in a re-buckling process in the present invention;

FIG. 5b is a schematic structural diagram of the operating mechanism in the re-buckling process in the present invention;

FIG. 5c is a schematic diagram of a principle of the operating mechanism in the re-buckling process in the present invention;

FIG. 6a is a schematic structural diagram of the circuit breaker in a closed state in the present invention;

FIG. 6b is a schematic structural diagram of the operating mechanism in a closed state in the present invention;

FIG. 6c is a schematic diagram of a principle of the operating mechanism in the closed state in the present invention;

FIG. 7a is a schematic structural diagram of a phase-pole breaking unit in the present invention, in which a phase-pole moving contact and a phase-pole static contact are in a connecting state;

FIG. 7b is a schematic structural diagram of a phase-pole contact system in the present invention, in which a phase-pole moving contact and a phase-pole static contact are in a connecting state;

FIG. 8a is a schematic structural diagram of a phase-pole breaking unit in the present invention, in which a phase-pole moving contact is repelled;

FIG. 8b is a schematic structural diagram of a phase-pole contact system in the present invention, in which a phase-pole moving contact is repelled;

FIG. 9 is a schematic structural diagram of the phase-pole breaking unit in the present invention, in which the phase-pole moving contact and the phase-pole static contact are in a disconnecting state;

FIG. 10 is a schematic exploded view of the phase-pole breaking unit in the present invention;

FIG. 11 is a schematic exploded view of a phase-pole rotating shaft mechanism in the present invention;

FIG. 12 is a schematic diagram of an assembly relationship between a phase-pole housing and a thermomagnetic tripping mechanism in the present invention;

FIG. 13 is a schematic structural diagram of the thermomagnetic tripping mechanism in the present invention;

FIG. 14 is a schematic exploded view of a phase-pole arc-extinguishing system in the present invention;

FIG. 15a is a schematic structural diagram of the cooperation between the phase-pole contact system and a phase-pole arc-extinguishing system in the first embodiment of the present invention, in which the phase-pole contact system is in a connecting state;

FIG. 15b is a schematic structural diagram of the phase-pole arc-extinguishing system in the first embodiment of the present invention;

FIG. 16a is a schematic structural diagram of the cooperation between the phase-pole contact system and a phase-pole arc-extinguishing system in the second embodiment of the present invention, in which the phase-pole contact system is in a disconnecting process;

FIG. 16b is a schematic structural diagram of the phase-pole arc-extinguishing system in the second embodiment of the present invention;

FIG. 17a is a schematic structural diagram of the cooperation between the phase-pole contact system and a phase-pole arc-extinguishing system in a third embodiment of the present invention, in which the phase-pole contact system is in a disconnecting state; and

FIG. 17b is a schematic structural diagram of the phase-pole arc-extinguishing system in the third embodiment of the present invention.

Reference symbols represent the following components:
OD—breaking opening;
1S—first center; 2S—second center; 3S—third center; 4S—fourth center; 5S—fifth center; 6S—sixth center; 7S—seventh center; 8S—eighth center; 10S—tenth center; 11S—eleventh center; 13S—thirteenth center; 15S—fifteenth center; 16S—sixteenth center; 17S—seventeenth center; 18S—eighteenth center; 19S—nineteenth center; 20S—twentieth center; 21S—twenty-first center; 22S—twenty-second center; 23S—twenty-third center; 24S—twenty-fourth center;
1a—first shaft; 2a—second shaft; 3a—third shaft; 4a—fourth shaft; 6a—sixth shaft; 7a—seventh shaft; 8a—eighth shaft; 18a—eighteenth shaft; 19a—nineteenth shaft; 20a—twentieth shaft; 21a—twenty-first shaft; and
1—support; 1-0—slide rail; 2—handle; 3—rocker arm; 4—energy storage spring; 5—energy storage spring shaft; 6—reset structure; 7—jump catch; 9—re-buckle; 10—lock buckle; 11—lock buckle spring; 14—first crank; 15—crank limiting portion; 16—first link; 18—slider; 19—second link; 20—slider shaft; 21—second crank; 23—third link; 25—third crank; 28—phase-pole driving shaft; 29—fourth link; 30—N-pole rotating shaft; 31—N-pole driving shaft; 32—transmission jump buckle; 34—first draw bar; 36—first draw bar reset spring; 37—side plate link; 38—first draw bar limiting shaft; 39—phase-pole rotating shaft; 40—phase-pole conductor; 41—phase-pole moving contact; 44—phase-pole contact spring; 45—first phase-pole contact spring shaft; 46—second phase-pole contact spring shaft; 47—first transmission structure; 48—phase-pole connecting shaft; 49—grid set; 50—arc-striking member; 51—arc-extinguishing partition plate; 52—arc-striking plate of primary arc-extinguishing chamber; 53—arc-striking plate of secondary arc-extinguishing chamber; 50-0—arc-striking member main body; 50-0a—first main body portion; 50-0b—second main body portion; 50-01—arc runway structure; 50-02—arc-striking member transition portion; 50-010—arc running plate; 50-011—arc runway plate connecting part; 50-012—U-shaped arc-extinguishing cavity; 50-1—primary arc-striking plate of arc-striking member; 50-2—arc secondary arc-striking plate of arc-striking member; 54—primary isolation grid; 55—secondary isolation grid; 56-1—first insulating plate; 56-2—second insulating plate; 57—first magnetic conductor plate; 58—second magnetic conductor plate; 59—third magnetic conductor plate; 60—fourth magnetic conductor plate; 61—fifth magnetic conductor plate; 62—sixth magnetic conductor plate; 63—seventh magnetic conductor plate; 64—conductor connecting shaft; 65—second transmission structure; 66—third transmission structure; 67—conductor plate; 68—magnetic yoke; 69—armature; 70—armature transmission member; 71—armature reset spring; 72—second draw bar; 74—bimetallic element; 75—armature shaft; 76—armature transmission member shaft; 77—first phase-pole positioning shaft; 78—second phase-pole positioning shaft; 79—first N-pole positioning shaft; 80—second N-pole positioning shaft; 81—first phase-pole insulating sleeve; 82—second phase-pole insulating sleeve 82; 92—N-pole static contact; 93—phase-pole contact system; 94—phase-pole arc-extinguishing chamber; 94-1—main grid set; 94-2—secondary grid set; 96—quick tripping device; 100—operating mechanism; 101—phase-pole breaking unit; 103—face cover; 104—base; 105—thermomagnetic tripping mechanism; 106—first phase-pole half-housing; 107—second phase-pole half-housing; 109—third insulating board; 110—fourth insulating board; 111—phase-pole static contact; 113—transmission link; 490—arc-extinguishing grid; and 940—N-pole arc-extinguishing system.

### DETAILED DESCRIPTION OF THE INVENTION

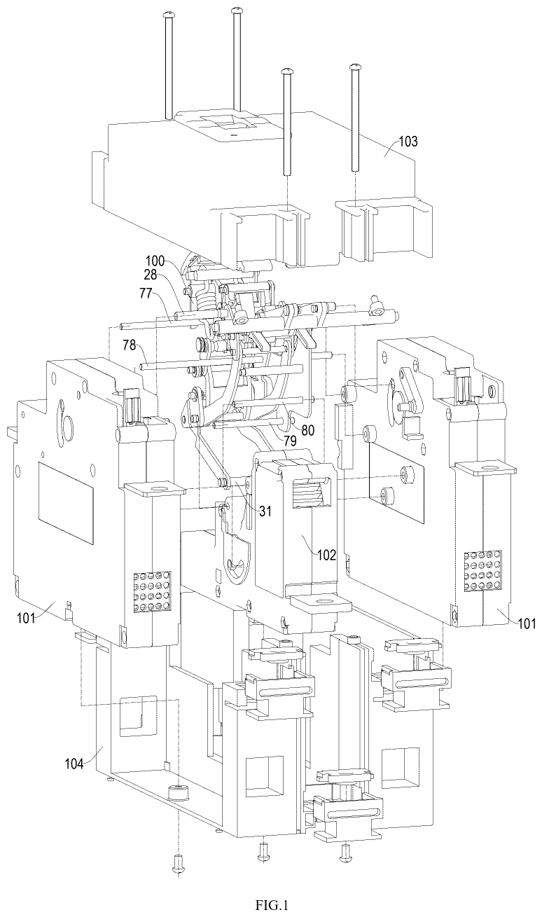

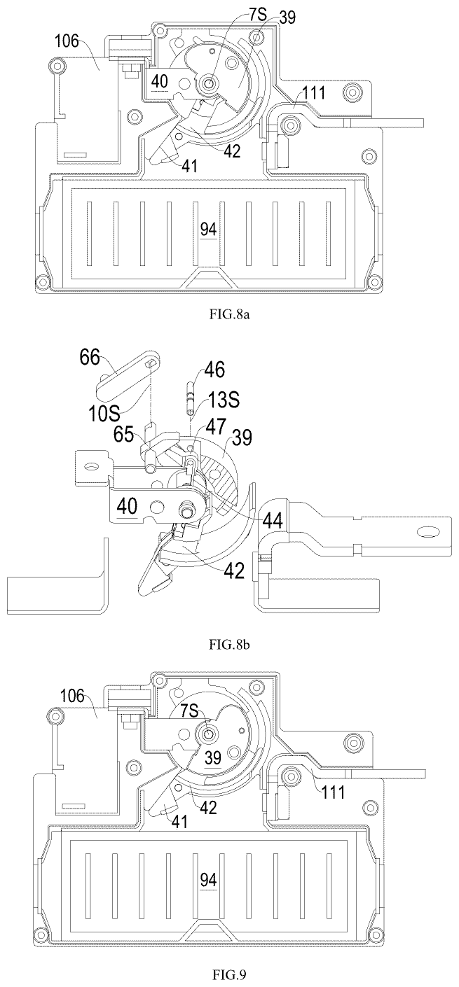

The specific implementation of a circuit breaker of the present invention will be further described below with reference to the embodiments given in FIGS. 1 to 17b. The circuit breaker of the present invention is not limited to the description of the following embodiments.

As shown in FIGS. 1, 4a, 5a, and 6a, the circuit breaker of the present invention includes an operating mechanism 100 and at least one set of breaking unit, wherein the at least one set of breaking unit is a phase-pole breaking unit, and the operating mechanism 100 is in driving connection with the breaking unit to drive the driving unit to be closed or broken, so that the circuit breaker is closed and opened. Further, the circuit breaker of the present invention is preferably a multi-phase circuit breaker, e.g., a two-phase (2P or P+N), three-phase (2P+N) or four-phase (3P+N) circuit breaker.

As shown in FIG. 1, the circuit breaker of the present invention further includes a circuit breaker outer housing for accommodating and mounting the operating mechanism 100 and the breaking units, wherein the circuit breaker outer housing includes a outer-housing main body (not shown), a face cover 103 and a base 104, the base 104 is arranged in a space formed by the outer-housing main body and the face cover 103 that are oppositely buckled together, and the operating mechanism 100 and the breaking units are respectively arranged in corresponding spaces of the base 104. Further, the base 104 is provided with a plurality of installation spaces arranged side by side, wherein each installation space accommodates one breaking unit.

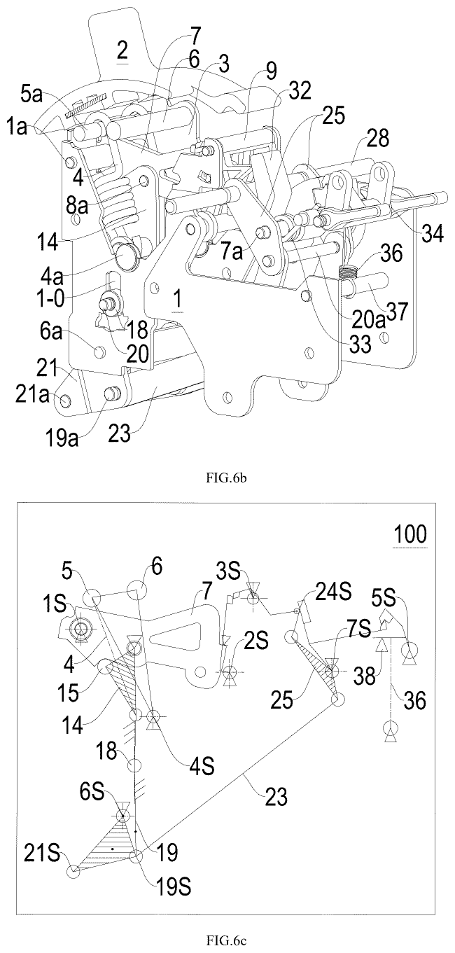

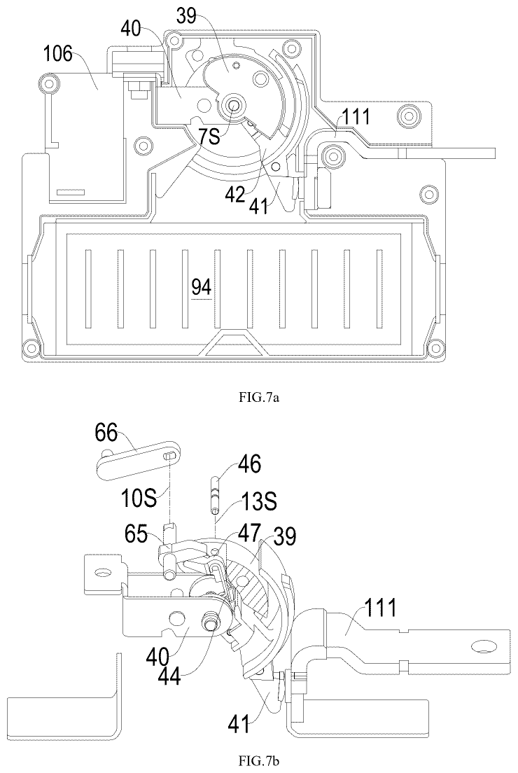

As shown in FIGS. 7a, 8a, 9-10, and 12, each phase-pole breaking unit includes a phase-pole housing. The phase-pole housing includes a first phase-pole half-housing 106 and a second phase-pole half-housing 107 which are oppositely buckled, wherein the first phase-pole half-housing 106 and the second phase-pole half-housing 107 are oppositely buckled to form a phase-pole installation space which is used for accommodating a phase-pole contact system 93 and a phase-pole arc-extinguishing system 94. Further, the phase-pole housing is of a convex structure as a whole, a phase-pole rotating shaft structure of the phase-pole contact system 93 is arranged at the upper part of the convex structure, and the phase-pole arc-extinguishing system 94 is arranged at the lower part of the convex structure. Further, the phase-pole housing is also provided with a tripping mechanism mounting cavity that is used for accommodating a thermomagnetic tripping mechanism 105 (described later). The phase-pole installation space and the tripping mechanism mounting cavity are arranged independently of each other. A partition wall is preferably arranged between the tripping mechanism mounting cavity and the phase-pole installation space. The partition wall is provided with an avoidance opening for a conductor plate 67 of the thermomagnetic tripping mechanism 105 to be connected with a phase-pole conductor 40 of the phase-pole rotating shaft mechanism. The tripping mechanism mounting cavity is located on one side of the phase-pole rotating shaft mechanism in a horizontal direction of the operating mechanism 100.

The circuit breaker in the present embodiment is preferably a 2P+N-type three-phase circuit breaker, which includes three sets of breaking units. The three sets of breaking units are preferably arranged side by side along the thickness direction of the operating mechanism 100 (that is, a side-by-side direction of two support side plates of a support 1 of the operating mechanism 100), wherein one set of breaking unit is a N-pole breaking unit 102 for breaking and closing an N-pole circuit circuit, and the other two sets of breaking units are phase-pole breaking units 101 for breaking and closing corresponding phase-pole circuits. The two sets of phase-pole breaking units 101 are preferably distributed on both sides of the N-pole breaking units 102 and are located on both sides of the two support side plates of the support 1 of the operating mechanism 100 respectively.

As shown in FIGS. 1, 4a, 5a, 6a, and 10, the operating mechanism 100 is connected to the phase-pole housings through a first phase-pole positioning shaft 77 and a second phase-pole positioning shaft 78 which are arranged side by side at intervals. The first phase-pole positioning shaft 77 and the second phase-pole positioning shaft 78 preferably pass through the support side plates of the support 1 of the operating mechanism 100 and the phase-pole housings. Parts of the first phase-pole positioning shaft 77 and the second phase-pole positioning shaft 78, which are inserted into the phase-pole housings, are preferably sleeved with a first phase-pole insulating sleeve 81 and the second phase-pole insulating sleeve 82 respectively, so as to prevent different phase-pole breaking units from interphase breakdown through the first phase-pole positioning shaft 77 and the second phase-pole positioning shaft 78 under a high voltage.

As shown in FIG. 1, the operating mechanism 100 is connected to a N-pole housing through a first N-pole positioning shaft 79 and a second N-pole positioning shaft 80 which are arranged side by side at intervals. The first N-pole positioning shaft 79 and the second N-pole positioning shaft 80 preferably pass through the support side plates of the support 1 of the operating mechanism 100 and the N-pole housing.

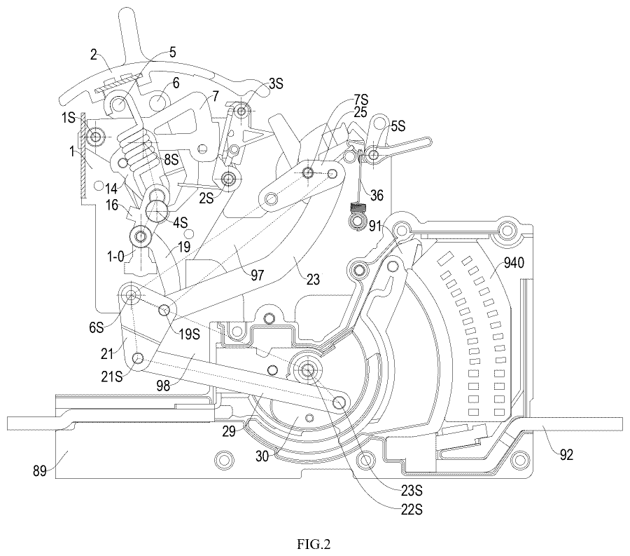

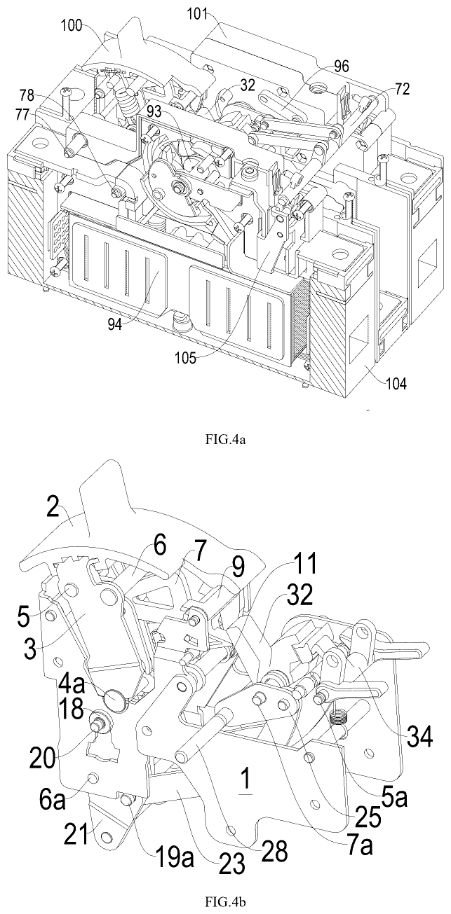

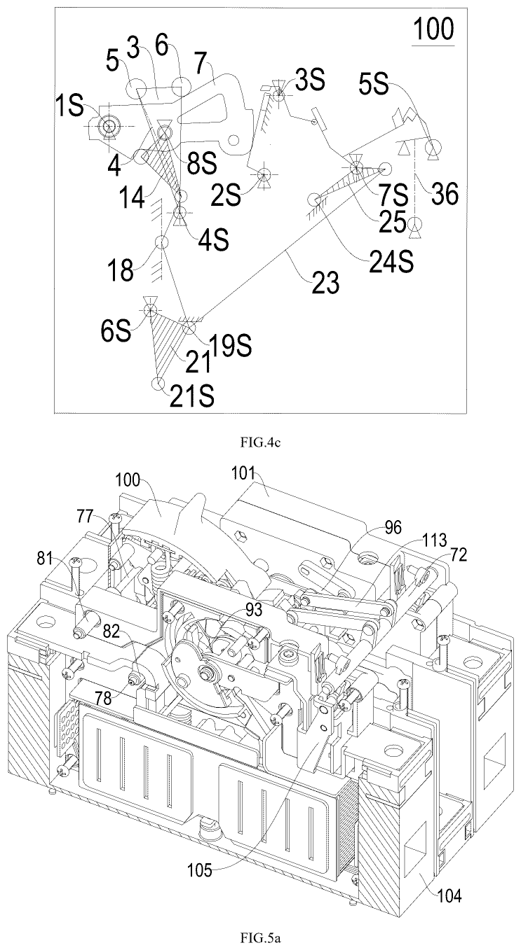

As shown in FIGS. 4a, 5a, 6a, 7a-11, 14, 15a, 16a, and 17a, each phase-pole breaking unit 102 includes a phase-pole contact system 93. The phase-pole contact system 93 includes a phase-pole rotating shaft mechanism and a phase-pole static contact 111 that are cooperatively used. The phase-pole rotating shaft mechanism is rotatably arranged in the phase-pole housing around a seventh center 7S. The phase-pole rotating shaft mechanism includes a phase-pole rotating shaft 39 that is rotatably arranged and a phase-pole moving contact 41 that is arranged on the phase-pole rotating shaft 39 and cooperates with the phase-pole static contact 111. The phase-pole rotating shaft mechanism is driven by the operating mechanism 100 to be closed with or broken from the phase-pole static contact 111, so that the phase-pole breaking unit is closed or broken. Further, each phase-pole breaking unit 102 further includes a phase-pole arc-extinguishing system 94 that cooperates with the phase-pole contact system. In a horizontal direction of the operating mechanism 100, the phase-pole rotating shaft mechanism and the operating mechanism 100 are arranged side by side. In a vertical direction of the operating mechanism 100, the phase-pole rotating shaft mechanism and the phase-pole arc-extinguishing system 94 are arranged side by side. The above-mentioned layout makes a trajectory of the phase-pole moving contact 41 breaking from the phase-pole static contact 111 be directly opposite to a bottom surface of a housing of the phase-pole breaking unit 102, which is conducive to a horizontal design of the phase-pole arc-extinguishing system 94, provides a larger design space for the phase-pole arc-extinguishing system, is conducive to improving a heat capacity of the phase-pole arc-extinguishing system 94, and improves a breaking voltage upper limit of the phase-pole arc-extinguishing system 94. As shown in FIGS. 2, and 4a-6c, the horizontal direction of the operating mechanism 100 is a left-right direction, and the vertical direction of the operating mechanism 100 is an up-down direction.

As shown in FIGS. 7b, 8b, and 11, an embodiment of the phase-pole rotating shaft mechanism is provided. The phase-pole rotating shaft mechanism includes a phase-pole rotating shaft 39, a phase-pole moving contact 41, a phase-pole contact spring 44 and a phase-pole conductor 40. A phase-pole rotating shaft mounting cavity is formed in the middle of the phase-pole rotating shaft 39. The phase-pole moving contact 41 includes a phase-pole moving contact connecting end and a phase-pole moving conductor rod, wherein one end of the phase-pole moving conductor rod is connected to the phase-pole moving contact connecting end, and the other end of the phase-pole conductor rod is provided with a phase-pole moving contact point. The phase-pole moving contact connecting end is rotatably arranged in the phase-pole rotating shaft mounting cavity around a fifteenth center 15S. The fifteenth center 15S coincides with a seventh center 7S. The phase-pole conductor 40 includes a conductor connecting portion of a U structure. The conductor connecting portion includes a connecting portion bottom plate and a pair of connecting portion connecting arms. A free end of each connecting portion connecting arm is rotatably connected to the phase-pole moving contact connecting end. The two connecting portion connecting arms are also connected via a conductor connecting shaft 64, such that the two connecting portion connecting arms press against the phase-pole moving contact connecting end. The conductor connecting shaft 64 is located between the connecting portion bottom plate and a free end of the connecting portion connecting arm. The phase-pole rotating shaft 39, the connecting portion connecting arm and the phase-pole moving contact connecting end are connected via the phase-pole connecting shaft 48. The phase-pole contact spring 44 is arranged in the phase-pole rotating shaft mounting cavity, wherein one end of the phase-pole contact spring 44 is connected to the phase-pole moving contact 41 through a first phase-pole contact spring shaft 45, and the other end of the phase-pole contact spring 44 is rotatably arranged on the phase-pole rotating shaft 39 around a thirteenth center 13S.

As shown in FIGS. 7a-8b, when the phase-pole rotating shaft mechanism rotates around the seventh center 7S to drive the phase-pole moving contact 41 and the corresponding phase-pole static contact 111 to be closed or broken, the fifteenth center 15S is located on one side of an axis of the phase-pole contact spring 44, and the phase-pole contact spring 44 exerts an acting force to the phase-pole moving contact 41, such that the phase-pole moving contact 41 is in limiting fit with the phase-pole rotating shaft 39 to keep relatively stationary. As shown in FIGS. 8a-8b, when the phase-pole moving contact 41 is repelled by an electric repulsion force between the phase-pole moving contact 41 and the phase-pole static contact 111, and the phase-pole moving contact 41 drives the phase-pole contact spring 44 to rotate over a dead center, so that the fifteenth center 15S is located on the other side of the axis of the phase-pole contact spring 44; and the phase-pole contact spring 44 exerts an acting force to the phase-pole moving contact 41 to lock the phase-pole moving contact 41 at a disconnecting position, so as to avoid the phase-pole moving contact 41 from falling back to be closed with the phase-pole static contact 111 again so as to result in secondary short-circuiting.

As shown in FIGS. 7b, 8b, and 11, the phase-pole rotating shaft mechanism further includes an insulator 42. The insulator 42 includes an insulator mounting cavity for accommodating the phase-pole moving conductor rod of the phase-pole moving contact 41, and an insulator arc barrier. The insulator arc barrier cooperates relatively with a circumferential side wall of the phase-pole rotating shaft 39. When the phase-pole moving contact 41 rotates relative to the phase-pole rotating shaft 39 (e.g., when the phase-pole moving contact 41 is repelled by an electric repulsion force), a gap between the phase-pole moving contact 41 and the phase-pole rotating shaft 39 is blocked, so as to avoid electric arc particles from entering the phase-pole rotating shaft mounting cavity, prevent the phase-pole rotating shaft 39 from being stuck inside, and isolate the phase-pole rotating shaft mounting cavity from the corresponding phase-pole arc-extinguishing system 94, which is conducive to an electric arc gas entering the arc-extinguishing system 94.

As shown in FIG. 2, each N-pole breaking unit 101 includes an N-pole contact system. The N-pole contact system includes an N-pole rotating shaft mechanism and an N-pole static contact 92 that are cooperatively used. The N-pole rotating shaft mechanism includes an N-pole rotating shaft 30 that is rotatably arranged and an N-pole moving contact 91 that is arranged on the N-pole rotating shaft 30 and cooperates with the N-pole static contact 92. The N-pole rotating shaft mechanism is driven by the operating mechanism 100 to be closed with or broken from the N-pole static contact 92, so that the N-pole breaking unit is closed or broken. Further, the N-pole breaking unit 101 further includes an N-pole arc-extinguishing system 940 that is used in conjunction with the N-pole contact system; and in a horizontal direction of the operating mechanism 100, the N-pole contact system and the N-pole arc-extinguishing system 940 are arranged side by side.

The N-pole rotating shaft mechanism is the same as the phase-pole rotating shaft mechanism, which will not be described here.

As shown in FIGS. 1-6c, an embodiment of the operating mechanism is shown. The operating mechanism has three working states, namely an opened state, a closed state and a tripped state (opened-tripped state), and the operating mechanism in the tripped state can be switched to the opened state by re-buckling.

As shown in FIGS. 2-3, 4b-4c, 5b-5c, and 6b-6c, the operating mechanism 100 includes a support 1, and a rocker arm assembly, a jump buckle 7, a lock buckle 10 in buckling fit with the jump buckle 7 and a re-buckle 9 in limiting fit with the lock buckle 10 which are rotatably arranged on the support 1 respectively, and a first crank 14, an energy storage spring 4, a slide rail 1-0 fixed relative to the support 1, a slider 18, a first link 16, a second link 19, a second crank 21 rotatably arranged around a sixth center 6S, a third link 23, a third crank 15, and a fourth link 29. The rocker arm assembly has three working positions, which are a closing position, a tripping position and an opening position, which are distributed sequentially and correspond to the closed state, the tripped state and the opened state of the operating mechanism 100 respectively. When the rocker arm assembly is switched between the closing position and the opening position, the energy storage spring 4 first stores energy and then releases energy to drive the operating mechanism to be quickly switched between the closed state and the opened state. The first crank 14 is rotatably arranged on the jump buckle 7S around an eighth center 8S, the other end of the first crank 14 is rotatably connected to one end of the first link 16 and one end of the energy storage spring 4 around an eighteenth center 18S, the other end of the first link 16 is connected to the slider 18, and the other end of the energy storage spring 4 is rotatably connected to the rocker arm assembly. The phase-pole rotating shaft 39 and the third crank 25 are rotatably arranged around the seventh center 7S respectively, and the N-pole rotating shaft 30 is rotatably arranged around a twenty-second center 22S. One end of the second link 19 is rotatably connected to the slider 18, and the other end of the second link 19 is rotatably connected to the second crank 21 around a nineteenth center 19S to drive the second crank 21 to rotate. One end of the fourth link 29 is rotatably connected to the second crank 21, and the other end of the fourth link 29 is rotatably connected to the N-pole rotating shaft 30 to drive the N-pole rotating shaft 30 to rotate. One end of the third link 23 is rotatably connected to the second crank 21 around the nineteenth center 19S, and the other end of the third link 23 is rotatably connected to the third crank 25 to drive the third crank 25 to rotate. The third crank 25 is in driving connection with the phase-pole rotating shaft 39 to drive the phase-pole rotating shaft 39 to rotate. Further, the rocker arm assembly includes a re-buckling structure 6 that is used for driving the jump buckle 7 to be re-buckled with the lock buckle 10. When the operating mechanism 100 is in the tripped state, the rocker arm assembly swings to the opening position to drive the jump buckle 7 through the re-buckling structure 6, such that the jump buckle 7 restores the buckling fit with the lock buckle 10. The first crank 14 includes a crank limiting structure 15 that is in limiting fit with the jump buckle 7. When the operating mechanism 100 is in the closed state or the tripped state, the crank limiting portion 15 is in limiting fit with the jump buckle 7. The operating mechanism implements respective driving of the N-pole rotating shaft 30 and the phase-pole rotating shaft 39 by arranging two sets of four-link structures, and allows rotation centers of the N-pole rotating shaft 30 and the phase-pole rotating shaft 39 to be different, providing higher flexibility for the design of the operating mechanism and the layout of the circuit breaker.

As shown in FIGS. 2, 4b-4c, 5b-5c, and 6b-6c, in the vertical direction of the operating mechanism 100, the rocker arm assembly and the second crank 21 are respectively located at two ends of the operating mechanism 100, the phase-pole rotating shaft 39 and the N-pole rotating shaft 30 are arranged side by side, the third crank 25 is arranged close to the rocker arm assembly, and the N-pole rotating shaft 30 is arranged close to the second crank 21. That is, the rocker arm assembly and the third crank 25 are located on one side of the operating mechanism 100 in the horizontal direction, and the second crank 21 and the N-pole rotating shaft 30 are located on the other side of the operating mechanism 100 in the horizontal direction; and in the horizontal direction of the operating mechanism 100, the rocker arm assembly and the third crank 25 are arranged side by side, and the third crank 25, the phase-pole rotating shaft 39 and the N-pole rotating shaft 30 are located on the same side of the operating mechanism 100. Specifically, in a direction as shown in FIGS. 2, 4b-4c, 5b-5c, and 6b-6c, the rocker arm assembly and the second crank 21 are respectively located at upper and lower ends of the operating mechanism 100, the phase-pole rotating shaft 39 and the N-pole rotating shaft are arranged side by side at intervals in a vertical direction, the rocker arm assembly and the third crank 25 are located on the upper side, and the second crank 21 and the N-pole rotating shaft 30 are located on the lower side; and the third crank 25, the phase-pole rotating shaft 39 and the N-pole rotating shaft 30 are all located on the right side of the operating mechanism 100. In the operating mechanism 100 in the present embodiment, in the horizontal direction of the operating mechanism 100, the phase-pole rotating shaft 39 and the operating mechanism 100 are arranged side by side, such that a length size of the circuit breaker is fully utilized, more space is reserved for the design of the phase-pole arc-extinguishing system 94, and the horizontal design of the phase-pole arc-extinguishing system 94 can be realized.

As shown in FIGS. 2-3, 4b-4c, 5b-5c, and 6b-6c, the second crank 21, the third crank 25, the N-pole rotating shaft 30 and the phase-pole rotating shaft 39 are arranged to ratate synchronously in the same direction. That is, the second crank 21, the third crank 25, the N-pole rotating shaft 30 and the phase-pole rotating shaft 39 maintain synchronous rotation in the same rotation direction simultaneously. For example, the second crank 21, the third crank 25, the N-pole rotating shaft 30 and the phase-pole rotating shaft 39 rotate clockwise at the same time in the closing process of the operating mechanism, and rotate counterclockwise at the same time in the opening process of the operating mechanism.

As shown in FIGS. 2-3, 4b-4c, 5b-5c, and 6b-6c, the rocker arm assembly is rotatably arranged on the support 1 through a fourth center 4S. One end of the jump buckle 7 is rotatably arranged on the support 1 around a first center 1S, and the other end of the jump buckle 7 is in buckling fit with the lock buckle 10. the lock buckle 10 is rotatably arranged on the support 1 around a second center 2S. the re-trip 9 is rotatably arranged on the support 1 around a third center 3S. The third link 23 is rotatably connected to the second crank 21 around a nineteenth center 19S and is rotatably connected to the third crank 25 around a twentieth center 20S. One end of the fourth link 29 is rotatably connected to the second crank 21 around a twenty-first center 21S, and the other end of the fourth link 29 is rotatably connected to the N-pole rotating shaft 30 around a twenty-third center 23S. Further, the jump buckle 7 is rotatably arranged on the support 1 through a first shaft 1a whose axis coincides with a first center 1S. The rocker arm assembly is rotatably arranged on the support 1 through a fourth shaft 4a whose axis coincides with a fourth center 4S. the lock buckle 10 is rotatably arranged on the support 1 through a second shaft 2a whose axis coincides with a second center 2S. The re-buckle 9 is rotatably arranged on the support 1 through a third shaft 3a whose axis coincides with a third center 3S. The first crank 14 is rotatably connected to the jump buckle 7 through an eighth shaft 8a whose axis coincides with an eighth center 8S. The first crank 14, the first link 16 and the energy storage spring 4 are rotatably connected to an eighteenth shaft 18a whose axis coincides with an eighteenth center 18S. The second crank 21 is rotatably arranged on the support 1 through a sixth shaft 6a whose axis coincides with a sixth center 6S. The third crank 25 is rotatably arranged on the support 1 through a seventh shaft 7a whose axis coincides with the seventh center 7S. The second link 19, the third link 23 and the second crank 21 are rotatably connected to a nineteenth shaft 19a whose axis coincides with the nineteenth center 19S. The second link 19 is also rotatably connected to the third crank 25a through a twentieth shaft 20a whose axis coincides with the twentieth center 20S. The second crank 21 is rotatably connected to the fourth link 29 through a twenty-first shaft 21a whose axis coincides with the twenty-first center 21S.

As shown in FIGS. 1, 3, 5b, and 6b, the third crank 25 is in driving connection with the phase-pole rotating shaft 39 through a phase-pole driving shaft 28, and an axis of the phase-pole driving shaft 28 is arranged parallel to a rotation axis of the third crank 25; and the phase-pole housing is preferably provided with a phase-pole housing avoidance hole that is used for avoiding the phase-pole driving shaft 28, a shape of the phase-pole housing avoidance hole is matched with a moving trajectory of the phase-pole driving shaft 28, and the phase-pole housing avoidance hole is preferably a sector-shaped hole. Further, when the operating mechanism 100 is in the opened state or the tripped state, the phase-pole driving shaft 28 is in limiting fit with the support 1, which prevents the phase-pole rotating shaft 39 from further rotating, such that the phase-pole rotating shaft mechanism and the phase-pole moving contact 41 are limited in the breaking position.

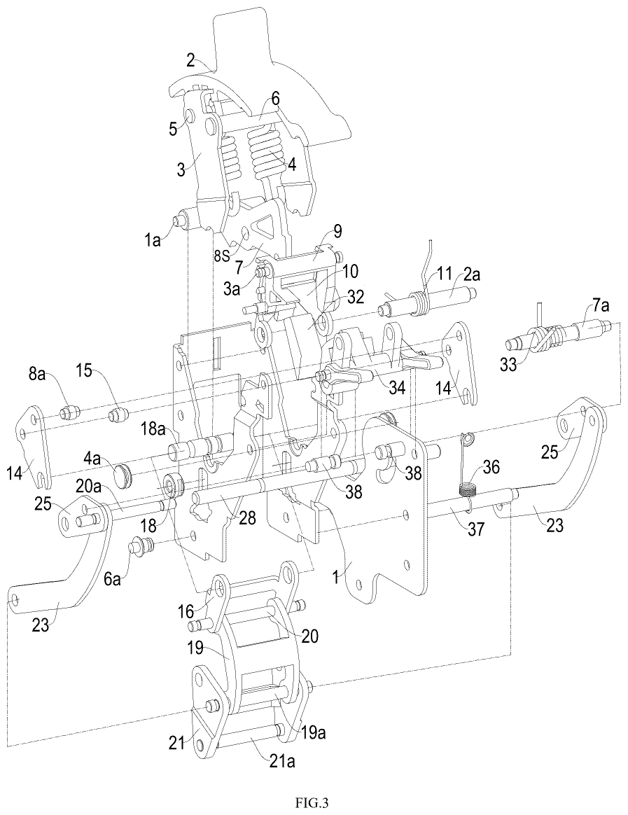

As shown in FIGS. 3, 4b, and 5b, the support 1 is provided with a third crank guide hole, the twentieth shaft 20a is inserted into the third crank guide hole, and a shape of the third crank guide hole is matched with a moving trajectory of the twentieth shaft 20a. Further, the third crank guide hole is a sector-shaped hole.

As shown in FIG. 3, the operating mechanism 100 further includes a lock buckle spring 11. the lock buckle spring 11 is a torsion spring sleeving on the second shaft 2a, and two ends of the torsion spring are matched with the lock buckle 10 and the re-buckle 9 respectively.

As shown in FIGS. 4a-5c, when the operating mechanism 100 is in the opened state or the tripped state, the nineteenth shaft 19a is in limiting fit with the support 1, preventing the second crank 21 from further rotating. Further, the nineteenth shaft 19a abuts against side edges of the support side plates of the support 1 in order to achieve limiting fit.

As shown in FIGS. 2, 4c, 5c, and 6c, the fourth center 4S, the seventh center 7S, the twenty-second center 22S and the sixth center 6S are sequentially located at four vertices of a quadrilateral. Further, the fourth center 4S, the seventh center 7S, the twenty-second center 22S and the sixth center 6S are sequentially located at four vertices of a quadrilateral in a clockwise direction and are arranged parallel to one another at intervals. Furthermore, the seventh center 7S, the twenty-second center 22S and the sixth center 6S are sequentially located at three vertices of a triangle in a clockwise direction, and the triangle is preferably an acute triangle.

As shown in FIGS. 2, 4c, 5c, and 6c, the sixth center 6S, the seventh center 7S, the twentieth center 20S and the nineteenth center 19S are sequentially located at four vertices of a quadrilateral. Further, the sixth center 6S, the seventh center 7S, the twentieth center 20S and the nineteenth center 19S are sequentially located at four vertices of a quadrilateral in a clockwise direction. That is, the second crank 21, the third link 23 and the third crank 25 form a set of four-link structure which is the first four-link structure 97.

As shown in FIGS. 2, 4c, 5c, and 6c, the six center 6S, the twenty-second center 22S, the twenty-third center 23S and the twenty-first center 21S are sequentially located at four vertices of a quadrilateral. Further, the sixth center 6S, the twenty-second center 22S, the twenty-third center 23S and the twenty-first center 21S are sequentially located at four vertices of a quadrilateral in a clockwise direction. That is, the second crank 21, the fourth link 29 and the N-pole rotating shaft 30 form a set of four-link structure which is the second four-link structures 98.

According to the operating mechanism in the present embodiment, by arranging two sets of four-link structures, namely, the first four-link structure 97 and the second four-link structure 98, the action design requirements of operating mechanism and rotating shaft system of 2P and 2P+N-type circuit breakers are met, and a design scheme in which rotating shafts of multiple poles are of different axes (e.g., the phase pole rotating shaft 39 and the N-pole rotating shaft 30 are of different axes) is achieved.

As shown in FIG. 2, the second crank 21 is of a triangular plate structure, wherein a first apex angle is rotatably arranged around the sixth center 6S, a second apex angle is rotatably connected to the second link 19 and the third link 23 around the nineteenth center 19S respectively, and a third apex angle is rotatably connected to the fourth link 29 around the twenty-first center 21S. It should be pointed out that the structure of the second crank 21 is not limited to the triangular plate structure, as long as the positions of the sixth center 6S, the nineteenth center 19S and the twenty-first center 21S on the second crank 21 are distributed in a triangle, and an apex angle of the triangle corresponding to the nineteenth center 19S is preferably is larger than or equal to 90°.

As shown in FIG. 2, the third crank 25 is of a triangular plate structure, wherein a first apex angle is rotatably arranged around the seventh center 7S, a second apex angle is rotatably connected to the third link 23 around the twentieth center 20S, and a third apex angle is rotatably connected to the phase-pole rotating shaft 39 around a twenty-fourth center 24S. It should be pointed out that the structure of the third crank 25 is not limited to the triangular plate structure, as long as the positions of the seventh center 7S, the twentieth center 20S and the twenty-fourth center 24S on the third crank 25 are distributed in a triangle, and an apex angle of the triangle corresponding to the seventh center 7S is preferably is larger than 90°.

As shown in FIGS. 4b-4c and 5b-5c, when the operating mechanism 100 is in the opened or tripped state, the slider 18 is in limiting fit with the slide rail 1-0 to prevent the slider 18 from sliding. The slider 18 converts a movement position of the first link 16 in the opening and closing processes of the operating mechanism 100 into a displacement of the slider 18, which is conducive to the actual measurement and the adjustment of parameters such as a size of a structure connected to the slider 18. In addition, the rotation of the mechanism links and the transfer of a torque can be implemented by the first crank 14, the first link 16 and the slider 18, and the operating mechanism can implement the opening, closing and tripping operations without the connection to the phase-pole rotating shaft 39 and/or N-pole rotating shaft, which is convenient for the modular production of the operating mechanism 100. That is, in the operating mechanism 100, the slide rail 1-0 provides a guiding function for the slider 18, and also serves as a supporting point to provide a supporting force for the first link 16 and the slider 18, so that the operating mechanism 100 may have the stable closing position, opening position and tripping position without the connection to the rotating shaft mechanism of the breaking unit, making the operating mechanism 100 become an independently operable component, which is conducive to the modular assembly and production of the operating mechanism 100 and provides more design space for the distribution of the operating mechanism 100 in the circuit breaker. In addition, in actual production, the operating mechanism 100 does not need to cooperate with a rotating shaft mechanism of the breaking unit, which avoids the loss of the contact system of the breaking unit during the test process and reduces R&D and production cost.

The slide rail 1-0 is preferably of a groove-like structure or a hole-like structure.

The slide rail 1-0 may be preferably arranged on the support 1. It should be pointed out that the slide rail 1-0 may also not be arranged on the support 1, but on a supporting structure independent from the operating mechanism 100, e.g., a housing structure for accommodating the operating mechanism 100 or a housing for accommodating the breaking unit.

As shown in FIGS. 2-3, 4b-4c, 5b-5c and 6b-6c, the slide rail 1-0 is preferably a long straight hole arranged on the support 1, and the slider 18 reciprocates in the long straight hole along its extension direction. Further, one end of the long straight hole is open, and the other end of the long straight hole is closed and is in limiting with the slider 18, such that the slider 18 is limited in its opening position.

As shown in FIGS. 2, 4b, 5b and 6b, the support 1 includes two support side plates that are oppositely arranged. Each support side plate includes a first side plate portion and a second side plate portion which are connected to each other. In the horizontal direction of the operating mechanism 100, the first side plate portion and the second side plate portion are arranged side by side. The rocker arm assembly, the jump buckle 7, the lock buckle 10, the re-buckle 9 and the second crank 21 are rotatably arranged on the first side plate portion respectively. A V-shaped groove and a slide rail 1-0 are respectively arranged at two ends of the first side plate portion in the vertical direction of the operating mechanism 100. The rocker arm assembly is arranged to swing in the V-shaped groove. The third crank 25 is rotatably arranged on the second side plate portion. Further, the third crank guide hole is formed in the second side plate portion. Specifically, the first side plate portion and the second side plate portion are arranged side by side on the left and right, and the V-shaped groove is formed in the upper end of the first side plate portion, and the slide rail 1-0 is arranged at the lower end of the first side plate portion.

The first side plate portion and the second side plate portion are of an integrated structure or a split structure.

As shown in FIGS. 2, 4b, 5b and 6b, the operating mechanism 100 includes two sets of second cranks 21 which are symmetrically arranged, two sets of third links 23 which are symmetrically arranged, two sets of third cranks 25 which are symmetrically arranged, two sets of fourth links 29 which are symmetrically arranged, two sets of sliders 18 which are symmetrically arranged, two sets of first links 16 which are symmetrically arranged, two sets of first cranks 14 which are symmetrically arranged, two sets of energy storage springs 4 which are symmetrically arranged, and two sets of slide rails 1-0 which are symmetrically arranged on the two support side plates. The rocker arm assembly includes a handle 2 and a rocker arm 3 which are connected fixedly. The rocker arm 3 includes two rocker arm legs which are arranged oppositely, and the two rocker arm legs are rotatably arranged on the two support side plates respectively through the fourth shaft 4a (preferably, the fourth shaft 4a includes two independent shafts which are symmetrically arranged, and the two rocker arm legs are rotatably arranged in the V-shaped grooves of the two support side plates through the two independent shafts). The two rocker arm legs are preferably arranged in the V-shaped grooves of the two support side plates, and the two sets of first cranks 14 are respectively arranged on both sides of the jump buckle 7, and one ends of the two sets of first cranks 14 are rotatably connected to the jump buckle 7 through the eighth shaft 8a; the other ends of the two sets of first cranks 14, one ends of the two sets of first links 16 and one ends of two sets of energy storage springs 4 are connected rotatably through the eighteenth shaft 18a; and the other ends of the two sets of energy storage springs 4 are connected to the energy storage spring shaft 5. The energy storage spring shaft 5 is fixedly connected to the two rocker arm legs of the rocker arm 3 respectively. The two sets of energy storage springs 4 are preferably arranged on both sides of two sets of first cranks 14. The two sets of first links 16 are preferably arranged on both sides of the two sets of energy storage springs 4. The two set of sliders 18 are connected through slider shafts 20 and are respectively arranged on the two sets of slide rails 1-0. The other ends of the two sets of first links 16 and one ends of the two sets of second links 19 are rotatably connected to the sliders 18 through the slider shafts 20 respectively. The two sets of second cranks 21s are rotatably arranged on the two support side plates of the support 1 through the sixth shaft 6a respectively. The other ends of two sets of second links 19 and one ends of the third links 23 are rotatably connected to two sets of second cranks 21 through the nineteenth shaft 19a respectively. The two sets of third cranks 25 are rotatably arranged on the two support side plates through the seventh shaft 7a and preferably located between the two support side plates. The other ends of the two sets of third links 23 are rotatably connected to the two sets of third cranks 25 through the twentieth shaft 20a and preferably located between the two support side plates. The two sets of third cranks 25 are respectively in driving connection with the phase-pole rotating shaft 39 through the phase-pole driving shaft 28. One ends of the two sets of fourth links 29 are rotatably connected to the two sets of second cranks 21 respectively through the twenty-first shaft 21a, and the other ends of the two sets of fourth links 29 are rotatably connected to the N-pole rotating shaft 30 respectively through the N-pole driving shaft 31. The two sets of fourth links 29 are preferably located on two axial sides of the N-pole rotating shaft 30. According to the operating mechanism 100 in the present embodiment, the energy storage springs 4, the first cranks 14, the first links 16, the second links 19, the second cranks 21, the third links 23, the third cranks 25 and the fourth links 29 are arranged in such a manner that each two sets of symmetrical structures are arranged side by side, which is conducive to reducing the number of parts, reducing a position error generated by the operating mechanism 100 due to multi-link movement, and ensuring the reliability of hinge movement coordination and the action consistency of various breaking units of the circuit breaker. Therefore, the operating mechanism 100 has an important influence on improving the overall performance of the circuit breaker while applied in the circuit breaker.

Combined with FIGS. 4a-6c, a detailed description of a switching process of the operating mechanism 100 among the opened state, the tripped state and the closed state is specifically as follows.

As shown in FIGS. 4b-4c, 5b-5c, and 6b-6c, two ends of a swing stroke of the rocker arm 3 of the rocker arm assembly are a first stroke end and a second stroke end, respectively; two ends of the swing stroke of the rocker arm 3 are in limiting fit with two sides wall of the V-shaped groove of the support 1 respectively; and two ends of the energy storage spring 4 are a first energy storage spring end 20 and a second energy storage spring end, respectively, which are connected to the rocker arm assembly and the eighteenth shaft 18a respectively. Specifically, as shown in FIGS. 4b-4c, 5b-5c, and 6b-6c, the first stroke end and the second stroke end are a right end and a left end of the swing stroke of the rocker arm 3 respectively, the upper end of the energy storage spring 4 is the first energy storage spring end, and the lower end of the energy storage spring 4 is the second energy storage spring end.

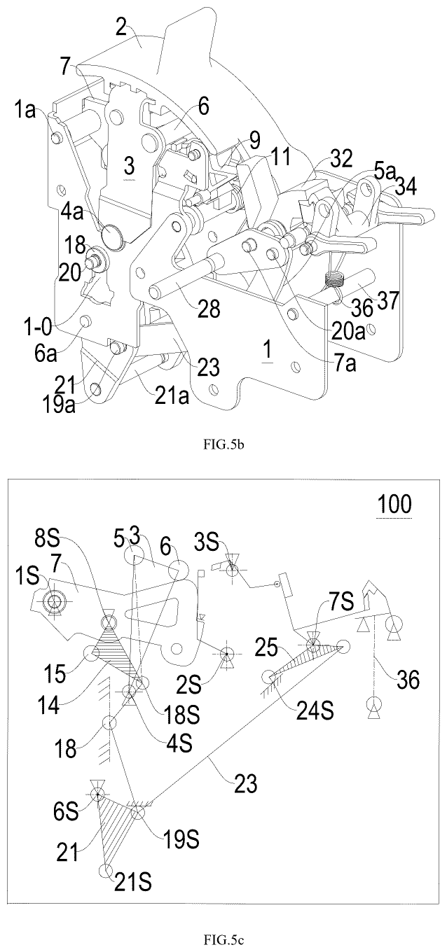

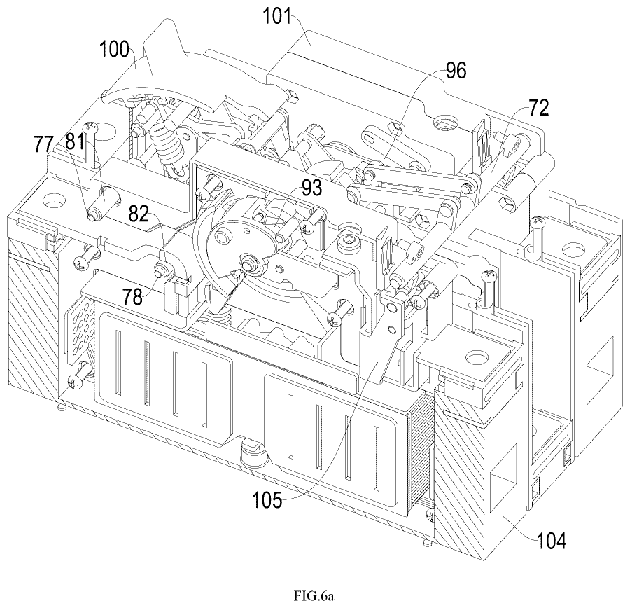

As shown in FIGS. 6a-6c, when the operating mechanism 100 is in the closed state, the rocker arm swings toward the second stroke end and drives the first energy storage spring end to rotate around the second energy storage spring end for energy storage. The energy storage spring 4 achieves maximum energy storage while reaching a first dead center position, and the energy storage spring 4 rotates over the first dead center position. The energy storage spring 4 releases energy and drives the first crank 14 to rotate in a second direction and drives the rocker arm 3 to swing to the second stroke end. The first crank 14 drives the slider 18 along the slide rail 1-0 through the first link 16 to slide from the closing position to the opening position. The slider 18 is in limiting fit with the slide rail 1-0 at the opening position (the slider 18 is preferably in limiting fit with the upper end of a straight hole taken as the slide rail 1-0 at the opening position) to prevent the slider 18 from sliding further, and meanwhile, the slider 18 drives the second crank 21 to rotate in a second direction through the second link 19. The second crank 21 drives the third crank 25 to rotate in the second direction through the third link 23, and the third crank 25 drives the phase-pole rotating shaft 39 to rotate in a breaking direction such that the phase-pole moving contact 41 is broken from the corresponding phase-pole static contact 111. The phase-pole moving contact 41 is preferably limited in the disconnecting position by the phase-pole housing, and meanwhile, the second crank 21 drives the N-pole rotating shaft 30 to rotate to the breaking direction (preferably, the second direction) through the fourth link 29, so that the N-pole moving contact 91 is broken from the N-pole static contact 92. Specifically, as shown in FIGS. 6a-6c, in the case that the operating mechanism 1 is switched from the closing position to the opening position, the slider 1-13 moves upward along the slide rail 1-0 till the slider 18 moves to and is in limiting with the upper end (i.e., the opening position of the slider 18) of the slide rail 1-0 so as to prevent the slider 18 from sliding further. The second direction is a counterclockwise direction. An axis of the energy storage spring 4 is a first axis. When the energy storage spring 4 is located at the first dead center position, the energy storage spring 4 reaches maximum energy storage and the eighth center 8S is located on the first axis. When the energy storage spring 4 rotates over the first dead center position around the second energy storage spring end, the first axis rotates over the eighth center 8S, so the eighth center 8S may also be regarded as the first dead center position. That is, the first axis of the energy storage spring 4 rotates over the eighth center 8S, namely, the energy storage spring 4 rotates over the first dead center position.

An action process of the operating mechanism 100 switched from the opened state to the closed state is as follows:

when the operating mechanism 100 is in the opened state, the rocker arm 3 swings toward the first stroke end and drives the first energy storage spring end to rotate around the second energy storage spring end till the energy storage spring 4 rotates over the first dead center position. The energy storage spring 4 releases energy and drives the first crank 14 to rotate in the first direction, such that the crank limiting portion 15 is in limiting fit with the jump buckle 7, thereby preventing the first crank 14 from rotating in the first direction; and meanwhile, the energy storage spring 4 drives the rocker arm 3 to swing to the first stroke end, and the first crank 14 drives the slider 18 to slide along the slide rail 1-0 through the first link 16 from the opening position to the closing position, and meanwhile the slider 18 drives the second crank 21 to rotate in the first direction through the second link 19, the second crank 21 drives the third crank 25 to rotate in the first direction through the third link 23, the third crank 25 drives the phase-pole rotating shaft 39 to rotate in a closed direction (preferably, the first direction), so that the phase-pole moving contact 41 is closed with the corresponding phase-pole static contact 111; and meanwhile the second crank 21 drives the N-pole rotating shaft 30 to rotate in a breaking direction (preferably, the first direction) through the fourth link 29, so that the N-pole moving contact 91 is broken from the N-pole static contact 92. The first direction and the second direction are opposite to each other. Specifically, when the operating mechanism 100 is switched from the opened state to the closed state, the slider 18 moves down to the closing position along the slide rail 1-0 from the opening position. The first direction is a clockwise direction.

As shown in FIGS. 4a-4c, and 6a-6c, a switching process of the operating mechanism 100 from the closed state to the tripped state (that is, the tripped-opened state) is as follows:

as shown in FIGS. 6a-6c, when the operating mechanism 100 is in the closed state, the re-buckle 9 is driven by an external force (e.g., an acting force exerted by a transmission jump buckle 32 on the re-buckle 9 as described below) to rotate and releases the limiting fit with the lock buckle 10. the lock buckle 10 rotates and releases the locking fit with the jump buckle 7. Under the effect of the energy storage spring 4, the rocker arm of the rocker arm assembly swings to the second stroke end till to the tripping position, and the jump buckle 7 rotates toward the second direction and drives the first crank 14 to rotate synchronously, until the jump buckle 7 is in limiting fit with a reset structure 6 of the rocker arm assembly. The first crank 14 drives the slider 18 along the slide rail 1-0 to slide from the closing position to the opening position through the first link 16. During the above process, the eighth center 8S is always kept on the same side of the axis of the energy storage spring 4, and meanwhile the slider 18 drives the second crank 21 to rotate in the second direction through the second link 19, the second crank 21 drives the third crank 25 to rotate in the second direction through the third link 23, the third crank 25 drives the phase-pole rotating shaft 39 to rotate in a breaking direction (preferably, the second direction), so that the phase-pole moving contact 41 is broken from the corresponding phase-pole static contact 111; and meanwhile, the second crank 21 drives the N-pole rotating shaft 30 to rotate in the breaking direction (preferably, the second direction) through the fourth link 29, so that the N-pole moving contact 91 is broken from the N-pole static contact 92; the operating mechanism 100 is switched to the tripped state as shown in FIGS. 4a-4c, that is, the tripped-opened state. Specifically, when the operating mechanism 100 is switched from the closed state to the tripped state, the slider 18 moves upward to the opening position along the slide rail 1-0 from the closing position.

As shown in FIGS. 4a-5c, a specific process of the operating mechanism 100 which is re-buckled from the tripped state (that is, switched from the tripped state to the opened state) is as follows:

when the operating mechanism 100 is in the tripped state as shown in FIGS. 4a-4c, as shown in FIGS. 5b-5c, the rocker arm 3 is driven by an external force (e.g., manual operation with an operator) to swing to the second stroke end, releasing the external force exerted on the re-buckle 9 to release the limiting fit with the lock buckle 10 (e.g., an acting force exerted by the transmission jump buckle 32 on the re-buckle 9 described below), which is in cooperation with that the lock buckle 10 and the re-buckle 9 are driven to reset by the torsion spring 11, such that the lock buckle 10 restores limiting fit with the re-buckle 9; and meanwhile the rocker arm 3 drives the jump buckle 7 to rotate in the first direction through the reset structure 6 till restoring the buckling fit with the lock buckle 10, the jump buckle 7 drives the slider 18 through the first crank 14 and the first link 16 to rotate from the opening position toward the closing position on the slide rail 1-0 but does not reach the closing position, and then moves back to the opening position; and meanwhile, the slider 18 drives the second crank 21 through the second link 19, and the second crank 21 drives the third crank 25 through the third link 23 to rotate in the first direction first and then to the second direction; the third crank 25 drives the phase-pole rotating shaft 39 to first rotate in the closing direction from the breaking position but will not be closed with the phase-pole static contact 111, then rotates to the breaking position in the breaking direction; after the external force that drives the rocker arm 3 to swing is removed, the operating mechanism 100 is switched to the opening state. Specifically, as shown in FIGS. 5b-5c, when the operating mechanism 100 is re-buckled from the tripped state, the rocker arm 3 is driven by an external force to rotate clockwise, the reset structure 6 of the rocker arm assembly drives the jump buckle 7 to rotate clockwise around the first center 1S, and the jump buckle 7 drives the slider 18 along the slide rail 1-0 slightly downward through the first crank 14 and the first link 16 but does not move to the closing position. then, the rocker arm 3 drives the energy storage spring 4 to rotate clockwise around the second energy storage spring end, so that the axis of the energy storage spring 4 rotates over the eighth center 8S, the energy storage spring 4 then drives the first crank 14 to rotate counterclockwise around the eighth center 8S, and the first crank 14 drives the slider 18 to slide down along the slide rail 1-0 through the first link 16 but does not reach the closing position, and then slides upward to the opening position; meanwhile, the slider 18 drives the second crank 21 through the second link 19, and the second crank 21 drives the third crank 25 through the third link 23 to rotate clockwise by a small angle and then rotate counterclockwise to reset; the third crank 25 drives the phase-pole rotating shaft 39 to rotate from the breaking position in the closed direction by a small angle first, the phase-pole moving contact 41 will not be closed with the phase-pole static contact 111, and then the phase-pole rotating shaft 39 rotates to the breaking position under the driving of the third crank 25.

After the operating mechanism 100 trips or opens from the closed state, the phase-pole driving shaft 28 is limited by the support 1 to prevent the phase-pole rotating shaft 39 from further rotating, and the nineteenth shaft 19a is limited by the support 1 to prevent the second crank 21 from further rotating, and the slider 18 is limited by the guide rail 1-0 to prevent the slider 18 from further moving. The above three processes occur at the same time in theory, but are difficult to carry out at the same time due to actual processing errors. In the present embodiment, it is ensured that the nineteenth shaft 19a is limited before the other two (the phase-pole driving shaft 28 and the slider 18), which is conducive to increasing a torque of the energy storage spring 4 against a friction force of a rotating shaft (i.e., the phase-pole rotating shaft 39 and/or the N-pole rotating shaft 30) during the closing process.

As shown in FIGS. 2-13, the operating mechanism 100 further includes a first draw bar 34 and a transmission jump buckle 32 that are in buckling fit with each other and rotatably arranged respectively. The phase-pole breaking unit further includes a thermomagnetic tripping mechanism 105. When an overload fault or a short-circuit fault occurs in a circuit where the phase-pole breaking unit is located, the thermomagnetic tripping mechanism 105 drives the first draw bar 34 to rotate and releases the buckling fit with the transmission jump buckle 32, the transmission jump buckle 32 rotates and drives the operating mechanism 100 to trip. Further, after the first draw bar 34 releases the buckling fit with the transmission jump buckle 32, the transmission jump buckle 32 drives the re-buckle 9 to rotate and release limiting fit with the lock buckle 10, and the lock buckle 10 rotates and releases the buckling fit with the jump buckle 9, so that the operating mechanism 100 trips.

As shown in FIGS. 2, 4c, 5c and 6c, the first draw bar 34 is rotatably arranged on the support 1 around the fifth center 5S, and the transmission jump buckle 32 is rotatably arranged on the support 1 around the seventh center 7S. Further, the first draw bar 34 is rotatably arranged on the support 1 through the fifth shaft 5a whose axis coincides with the fifth center 5S, and the transmission jump buckle 32 is rotatably arranged on the seventh shaft 7a. Further, the first draw bar 34 and the transmission jump buckle 32 are preferably located between the two support side plates of the support 1.

The first draw bar 34 includes a first draw bar hook portion, the transmission jump buckle 32 includes a transmission jump buckle hook portion, and the first draw bar hook portion and the transmission jump buckle hook portion are opposite and in buckling fit with each other.

As shown in FIGS. 2 and 3, the operating mechanism 100 further includes a first draw bar reset spring 36 and a transmission jump buckle reset spring 33. The first draw bar reset spring 36 exerts an acting force to the first draw bar 34, and the transmission jump buckle reset spring 33 exerts an acting force to the transmission jump buckle 32, so that the first draw bar 34 keeps in buckling fit with the transmission jump buckle 32. Preferably, the first draw bar hook portion and the transmission jump buckle hook portion have a tendency to move toward each other, so that the first draw bar hook portion is in firm buckling fit with the transmission jump buckle hook portion. Further, the first draw bar reset spring 36 is preferably a tension spring, wherein one end of the tension spring is connected to the first draw bar 34, and the other end of the tension spring is connected to the support 1 (the two support side plates of the support 1 are connected by a side plate link 37, and said “other end” is connected to the side plate link 37). The transmission jump buckle reset spring 32 is preferably a torsion spring and arranged to sleeve on the seventh shaft 7a, wherein one end of the tension spring cooperates with the support 1, and the other end of the tension spring cooperates with the transmission jump buckle 32. After the transmission jump buckle 32 releases the buckling fit with the first draw bar 34, the transmission jump buckle 32 is driven to rotate to drive the re-buckle 9 to rotate, so that the re-buckle 9 releases the limiting fit with the lock buckle 10.

As shown in FIG. 3, the operating mechanism 100 further includes a first draw bar limiting shaft 38 arranged on the support 1. After the first draw bar 34 releases the buckling fit with the transmission jump buckle 32, the first draw bar reset spring 36 drives the first draw bar 34 to rotate and abut against the first draw bar limiting shaft 38, so as to prepare for restoring the buckling fit between the transmission jump buckle 32 and the first draw bar 34.

As shown in FIGS. 4a, 5a, 6a, 10 and 12, the thermomagnetic tripping mechanism 105 further includes a second draw bar 72 rotatably arranged around an eleventh center 11S, wherein an axial direction of the second draw bar 72 is preferably the same as the side-by-side direction of the breaking units. The thermomagnetic tripping mechanisms 105 of the phase-pole breaking units share one second draw bar 72, and the second draw bar 72 is connected to the first draw bar 34 through a transmission link 113 to drive the first draw bar 34 to rotate. Further, the transmission jump buckle 32, the first draw bar 34 and the second draw bar 72 are sequentially arranged side by side on one side of the operating mechanism 100 in the horizontal direction of the operating mechanism 100.

As shown in FIG. 12, two ends of the second draw bar 72 are preferably rotatably arranged on the phase-pole housings of two sets of phase-pole breaking units 101 that are oppositely arranged. As another embodiment, the second draw bar 72 may also be disposed on the support 1 of the operating mechanism 100.

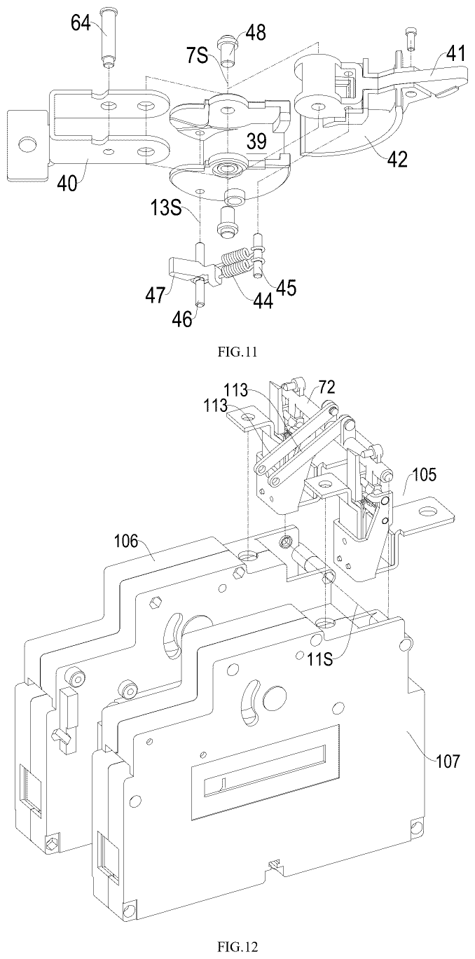

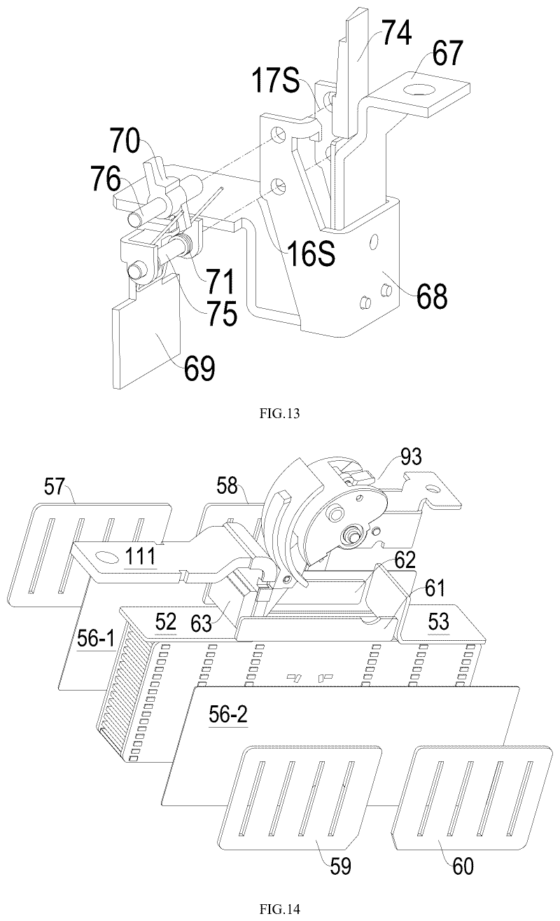

As shown in FIGS. 12-13, the thermomagnetic tripping mechanism 105 includes a magnetic yoke 68, an armature 69, an armature transmission member 70, a bimetallic element 74, a conductor plate 67 and an armature reset spring 71. The armature 69 and the armature transmission member 70 are rotatably arranged on the magnetic yoke 68 around a sixteenth center 16S and a seventeenth center 17S respectively, and the sixteenth center 16S and the seventeenth center 17S are arranged in parallel at intervals. The conductor plate 67 passes between the magnetic yoke 68 and the armature 69. The bimetallic element 74 is electrically connected to the conductor plate 67. The conductor plate 67 is connected in series with the contact system of the phase-pole breaking unit. The armature reset spring 71 cooperates with the armature 69, such that the armature 69 is separated from the magnetic yoke 68. Further, the armature transmission member 70 is rotatably arranged on the magnetic yoke 68 through an armature transmission member shaft 76, the armature 69 is rotatably arranged on the magnetic yoke 68 through an armature shaft 75, and the armature reset spring 71 is a torsion spring that is arranged to sleeve on the armature 75. Further, the conductor plate 67 is a wire-inlet end conductor plate of the phase-pole breaking unit, and is electrically connected to the phase-pole conductor 40 of the phase-pole rotating shaft mechanism.

According to the circuit breaker, when a circuit where the phase-pole breaking unit is located is short-circuited, the phase-pole moving contact 41 is repelled by an electric repulsion force between the phase-pole moving contact 41 and the phase-pole static contact 111, and drives the first draw bar 34 to rotate to release the buckling fit with the transmission jump buckle 32, thereby realizing rapid tripping of the circuit breaker. Specifically, as shown in FIGS. 8b and 11, the phase-pole breaking unit 101 further includes a first transmission structure 47, a second transmission structure 65 and a third transmission structure 66. The first transmission structure 47 is rotatably arranged around the second phase-pole contact spring 46 of the phase-pole rotating shaft mechanism. The second transmission structure 65 includes a second transmission shaft and a second transmission arm. The second transmission arm is arranged on and rotates in synchronization with the second transmission shaft. The third transmission structure 66 includes a third transmission arm and a third driving shaft. One end of the third transmission arm is connected to and rotates in synchronization with the second transmission shaft, and the third driving shaft is arranged at the other end of the third transmission arm. The first driving arm is respectively in transmission fit with the phase-pole moving contact 41 and the second transmission arm. When the phase-pole moving contact 41 is repelled by an electric repulsion force, the first transmission structure 47 is driven to rotate around the second phase-pole contact spring 46, the first transmission structure 47 drives the second transmission arm to rotate around the second transmission shaft, the second transmission shaft drives the third transmission arm to rotate, the third transmission arm drives the first draw bar 34 to rotate through the third driving shaft and release the buckling with the transmission jump buckle 32. Further, the second transmission shaft is rotatably inserted on a housing of the phase-pole breaking unit around a tenth center 10S, so that the third transmission structure 66 is located outside the phase-pole breaking unit. The first transmission structure 47 and the second transmission arm of the second transmission structure 65 are located in the phase-pole breaking unit, thereby improving the insulation performance and ensuring the safety of electricity utilization.

The present invention further includes a quick tripping device 96 (as shown in FIG. 6). The quick tripping device includes the operating mechanism 100, the transmission jump buckle 32, the first draw bar 34, the third transmission structure 66, the second transmission structure 65, the first transmission structure 47 and the phase-pole rotating shaft mechanism. When a short-circuit fault occurs in the circuit where the phase-pole breaking unit is located, the operating mechanism 100 is driven to quickly trip and open, thereby achieving short-circuit protection.

According to the circuit breaker, a repulsive self-locking function of the phase-pole moving contact 41 of the phase-pole rotating shaft mechanism 44, the quick tripping device 96 and the thermomagnetic tripping mechanism 105 implement a three-stage protection, which further increases an unlocking speed of the operating mechanism 100 in a current breaking process while ensuring a normal protection function of the thermomagnetic tripping mechanism 105. The repulsive self-locking function of the contact adds a safety guarantee for the circuit breaker to break a current, and also avoids the risk of secondary short-circuiting caused by contact dropping even if the breaking fails, so the combined effect of the three-stage protection improves the overall breaking performance of the circuit breaker.

According to the circuit breaker of the present invention, when the operating mechanism 100 is re-buckled from the tripped state, the handle 2 of the rocker arm assembly drives the transmission jump buckle 32 to reset and restores buckling fit with the first draw bar 34, the re-buckle 9 and the lock buckle 10 reset under the effect of the torsion spring 11 of the lock buckle, and meanwhile the reset structure 6 of the rocker arm assembly drives the jump buckle 7 to restores buckling fit with the lock buckle 10.

In the circuit breaker of the present invention, the first center 1S to the eighth center 8S, the tenth center 10S, the eleventh center, the thirteenth center 13S, the fifteenth center 15S to the twenty-fourth center 24S are arranged in parallel to one another, and each center is perpendicular to the horizontal direction and the vertical direction of the operating mechanism 100.

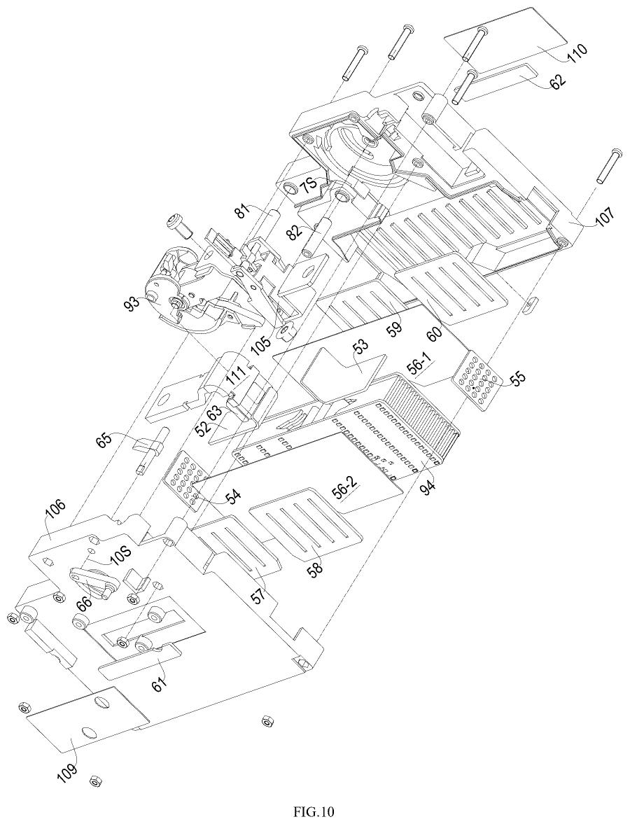

Combined with FIGS. 10, and 14-17b, the phase-pole arc-extinguishing system 94 is described.

The phase-pole arc-extinguishing system 94 has a variety of implementation modes, including at least three implementation modes shown in FIGS. 15a-17b. A common structure of the three implementation modes is as follows.

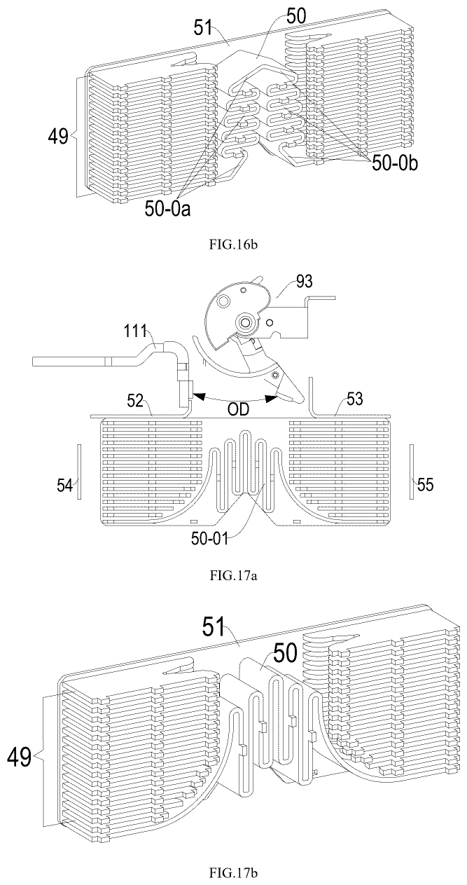

1. The phase-pole arc-extinguishing system 94 includes a primary arc-extinguishing chamber 94-1 and a secondary arc-extinguishing chamber 94-2 whose an electric arc inlets are arranged opposite to each other, and an arc-striking member 50; the arc-extinguishing member 50 includes an arc-striking member main body 50-0 arranged between electric arc inlets (one opposite ends of the primary arc-extinguishing chamber 94-1 and the secondary arc-extinguishing chamber 94-2 are the electric arc inlets of the primary arc-extinguishing chamber 94-1 and the secondary arc-extinguishing chamber 94-2 respectively) of the primary arc-extinguishing chamber 94-1 and the secondary arc-extinguishing chamber 94-2, as well as a primary arc-striking plate 50-1 of the arc-striking member and an arc-striking plate 50-2 of the arc-striking member which are connected to the arc-extinguishing member main body 50-0 respectively; the arc-striking member main body 50-0 is also opposite to a breaking opening OD formed by that the phase-pole moving contact 41 disconnecting from the phase-pole static contact 111; the primary arc-striking plate 50-1 of the arc-striking member extends to one side of the primary arc-extinguishing chamber 94-1 away from the phase-pole contact system 93; the secondary arc-striking plate 50-2 of the arc-striking member extends to one side of the secondary arc-extinguishing chamber 94-2 away from the phase-pole contact system 93; in other words, the primary arc-striking plate 50-1 of the arc-striking member is located on one side of the primary arc-extinguishing chamber 94-1 in a side-by-side direction of the arc-extinguishing grids of the primary arc-extinguishing chamber 94-1; the secondary arc-striking plate 50-2 of the arc-striking member is located on one side of the secondary arc-extinguishing chamber 94-2 in the side-by-side direction of the arc-extinguishing grids of the secondary arc-extinguishing chamber 94-2; and the primary arc-striking plate 50-1 of the arc-striking member and the secondary arc-striking plate 50-2 of the arc-extinguishing member are located on the same side of the primary arc-extinguishing chamber 94-1 and the secondary arc-extinguishing chamber 94-2. Further, as shown in FIG. 17a, when the phase-pole moving contact 41 is broken from the phase-pole static contact 111, the phase-pole static contact 111 and the primary arc-striking plate 50-1 of the arc-striking member are respectively located on both sides (preferably, upper and lower sides) of the primary arc-extinguishing chamber 94-1, and a free end of the phase-pole moving contact 41 and the secondary arc-striking plate 50-2 of the arc-striking member are respectively located on both sides (preferably, upper and lower sides) of the secondary arc-extinguishing chamber 94-2. The phase-pole arc-extinguishing system 94 includes the primary arc-extinguishing chamber 94-1 and the secondary arc-extinguishing chamber 94-2, such that an internal space of the phase-pole breaking unit is fully utilized, and the number, lengths, surface areas, thicknesses and gaps of the arc-extinguishing grids are increased, which is conducive to the cooling and cutting of electric arcs, prevents burn-through caused to excessively high temperature or blocking with larger particles and thus the short-circuiting possibility of the grids, and improves the heat capacity of the phase-pole arc-extinguishing system 94. The primary arc-extinguishing chamber 94-1 and the secondary arc-extinguishing chamber 94-2 are connected in series through the arc-striking member 50. The arc-striking member improves a utilization rate of the arc-extinguishing grids at the bottoms of the two arc-extinguishing chambers, plays the role in arc running and pulling, further cools the electric arcs to improve an arc voltage, reduces the conductivity of the electric arcs, takes an arc-striking effect, and is conducive to the electric arcs to enter two sections of arc-extinguishing chambers and limiting the current quickly.

The primary arc-extinguishing chamber 94-1 and the secondary arc-extinguishing chamber 94-2 each include a grid set 49. The grid set 49 includes a plurality of arc-extinguishing grids 490 which is arranged side by side at intervals. The arc-extinguishing grids 490 of each grid set 49 are preferably arranged side by side in a vertical direction of the operating mechanism 100. Further, the grid set 49 of the primary arc-extinguishing chamber 94-1 and the grid set of the secondary arc-extinguishing chamber 94-2 are symmetrical structures with each other, and the arc-extinguishing grids 490 of the same grid set 49 are parallel to each other.

2. The phase arc-extinguishing chamber 94 further includes an arc-striking plate 52 of the primary arc-extinguishing chamber and an arc-striking plate 53 of the secondary arc-extinguishing chamber. The arc-striking plate 52 of the primary arc-extinguishing chamber and the primary arc-striking plate 50-1 of the arc-striking member are oppositely arranged on both sides (in a direction as shown in FIGS. 15a-17b, preferably, upper and lower sides) of the primary arc-extinguishing chamber 94-1. In other words, the arc-striking plate 52 of the primary arc-extinguishing chamber and the primary arc-striking plate 50-1 of the arc-striking member are oppositely arranged and located on both sides of the primary arc-extinguishing chamber 94-1 in a side-by-side direction of the arc-extinguishing grids of the primary arc-extinguishing chamber 94-1. The arc-striking plate 52 of the primary arc-extinguishing chamber is preferably located between the primary arc-extinguishing chambers 94-1 of the phase-pole static contact 111. The arc-striking plate 52 of the secondary arc-extinguishing chamber and the secondary arc-striking plate 50-2 of the arc-striking member are oppositely arranged on both sides (in a direction as shown in FIGS. 15a-17b, preferably, upper and lower sides) of the secondary arc-extinguishing chamber 94-2. In other words, the arc-striking plate 53 of the secondary arc-extinguishing chamber and the secondary arc-striking plate 50-2 of the arc-striking member are located on both sides of the secondary arc-extinguishing chamber 94-2 in a side-by-side direction of the arc-extinguishing grids of the secondary arc-extinguishing chamber 94-2. The arc-striking plate 53 of the secondary arc-extinguishing chamber is preferably located between the phase-pole rotating shaft mechanism and the secondary arc-extinguishing chamber 94-2, and is oppositely spaced from the arc-striking plate 52 of the primary arc-extinguishing chamber.

3. The phase-pole arc-extinguishing system 94 further includes a magnetic blowing structure. The magnetic blowing structure increases the magnetic field intensity at a placement position, improves an electrodynamic force of the phase-pole moving contact 41, accelerates a speed of the electric arc from generation to entering the primary arc-extinguishing chamber 94-1 and the secondary arc-extinguishing chamber 94-2 and finally off the phase-pole arc-extinguishing system 94, shortens the arc ignition time, and improves the arc-extinguishing efficiency and performance. The magnetic blowing structure includes a first magnetic conductor plate 57, a second magnetic conductor plate 58, a third magnetic conductor plate 59, a fourth magnetic conductor plate 60, a fifth magnetic conductor plate 61, a sixth magnetic conductor plate 61 and a seventh magnetic conductor plate 63. The first magnetic conductor plate 57 and the third magnetic conductor plate 59 are oppositely arranged on both sides of the primary arc-extinguishing chamber 94-1 and are located between the primary arc-striking plate 51 of the arc-striking member and the phase-pole contact system 93. The first magnetic conductor plate 57, the arc-striking member main body 50-0 and the third magnetic conductor plate 59 integrally form a U-shaped structure enclosing the primary arc-extinguishing chamber 94-1. The second magnetic conductor plate 58 and the fourth magnetic conductor plate 60 are oppositely arranged on both sides of the secondary arc-extinguishing chamber 94-2 and are located between the secondary arc-striking plate 52 of the arc-striking member and the phase-pole contact system 93. The second magnetic conductor plate 58, the arc-striking member main body 50-0 and the fourth magnetic conductor plate 60 are integrally formed into a U-shaped structure enclosing the secondary arc-extinguishing chamber 94-2. The fifth magnetic conductor plate 61 and the sixth magnetic conductor plate 62 are oppositely arranged on both sides of the breaking opening OD. The seventh magnetic conductor plate 63 is arranged between one ends of the fifth magnetic conductor plate 61 and the sixth magnetic conductor plate 62 close to the phase-pole static contact 111. The fifth magnetic conductor plate 61, the sixth magnetic conductor plate 62 and the seventh magnetic conductor plate 63 are integrally in a U-shaped structure enclosing the breaking opening OD. Further, the phase-pole arc-extinguishing system 94 further includes a first insulating plate 56-1, a second insulating plate 56-2, a third insulating plate 109 and a fourth insulating plate 110. The first insulating plate 56-1 is arranged between the first magnetic conductor plate 57 and the primary arc-extinguishing chamber 94-1 and between the second magnetic conductor plate 58 and the secondary arc-extinguishing chamber 94-2. The second insulating plate 56-2 is arranged between the third magnetic conductor plate 59 and the primary arc-extinguishing chamber 94-1 and between the fourth magnetic conductor plate 60 and the secondary arc-extinguishing chamber 94-2. The third insulating plate 109 and the fourth insulating plate 110 are respectively arranged on both sides of the fifth magnetic conductor plate 61 and the sixth magnetic conductor plate 62. The above structural design is conducive to improving the insulation performance. Further, the first phase-pole half-housing 106 and the second phase-pole half-housing 107 of the phase pole housing are respectively provided with a fifth magnetic conductor plate limiting hole and a sixth magnetic conductor plate limiting hole which are used for limiting the fifth magnetic conductor plate 61 and the sixth magnetic conductor plate 62. The third insulating plate 109 and the fourth insulating plate 110 are respectively arranged on both sides of the first phase-pole half-housing 106 and the second phase-pole half-housing 107 and are respectively fixed thereon, so as to shield the fifth magnetic conductor plate limiting hole and the sixth magnetic conductor plate limiting hole respectively.

The phase-pole arc-extinguishing system 94 preferably includes two arc-extinguishing partition plates 51 which are oppositely arranged, and the primary arc-extinguishing chamber 94-1 and the secondary arc-extinguishing chamber 94-2 are arranged between the two arc-extinguishing partition plates 51. The arc-extinguishing grids of the primary arc-extinguishing chamber 94-1 and the arc-extinguishing grids of the secondary arc-extinguishing chamber 94-2 are respectively fixedly connected to the two arc-extinguishing partition plates 51. The first insulating plate 56-1 and the second insulating plate 56-2 are respectively located on both sides of the two arc-extinguishing partition plates 51.

4. The phase-pole arc-extinguishing system 94 further includes primary isolation grids 54 and secondary isolation grids 55, which are respectively arranged at air outlets of the primary arc-extinguishing chamber 94-1 and the secondary arc-extinguishing chamber 94-2 and are respectively located on both sides of the primary arc-extinguishing chamber 94-1 and the secondary arc-extinguishing chamber 94-2. The primary arc-extinguishing chamber 94-1 and the secondary arc-extinguishing chamber 94-2 are respectively communicated with an external environment of the phase-pole breaking units through the primary isolation grids 54 and the secondary isolation grids 55. Further, the primary isolation grids 54 and the secondary isolation grids 55 are respectively fixed on a pair of side walls of the phase-pole housing, which can effectively prevent the problems of short circuit and fire caused by larger electrically-charged particles sprayed to apparatuses around the circuit breaker, and play the effect of eliminating dissociation.

5. The arc-striking member main body 50-0 includes a first main body portion 50-0a opposite to the electric arc inlet of the primary arc-extinguishing chamber 94-1 and a second main body portion 50-0b opposite to the electric arc inlet of the secondary arc-extinguishing chamber 94-2 respectively. One end of the first main body portion 50-0a is connected to one end of the primary arc-striking plate 50-1 of the arc-striking member, the other end of the first main body portion 50-0a is connected to one end of the second main body portion 50-0b, and the other end of the second main body portion 50-0b is connected to the secondary arc-striking plate 50-2 of the arc-striking member. Further, the first main body portion 50-0a and the second main body portion 50-0b are symmetrical structures with each other.

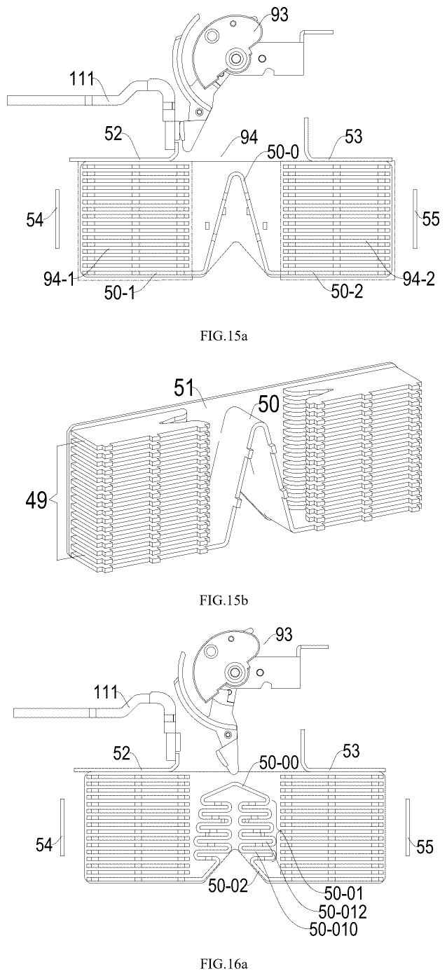

6. The arc-striking member main body 50-0 further includes an arc-striking end located between the arc-striking plate 52 of the primary arc-extinguishing chamber and the arc-striking plate 53 of the secondary arc-extinguishing chamber. As shown in FIGS. 16a-16b, a minimum spacing between the phase-pole moving contact 41 and the arc-extinguishing end during the movement process from the closing position to the breaking position is greater than a spacing between the arc-striking member main body 50-0 and the primary arc-extinguishing chamber 94-1, a spacing between the arc-striking member main body 50-0 and the secondary arc-extinguishing chamber 94-2, a spacing between the primary arc-striking plate 50-1 of the arc-striking member and the primary arc-extinguishing chamber 94-1, and a spacing between the secondary arc-extinguishing plate 50-2 of the arc-striking member and the secondary arc-extinguishing chamber 94-2. According to the circuit breaker of the present invention, when a short-circuit current flows through the phase-pole breaking unit, the phase-pole moving contact 41 is repelled by an electric repulsion force, an electric arc is generated between the phase-pole moving contact 41 and the phase-pole static contact 111, and an arc root is transferred to the primary arc-extinguishing chamber 94-1 under the action of airflow and the arc-striking plate 52 of the primary arc-extinguishing chamber. When the phase-pole moving contact 41 is opened to be opposite to the arc-striking member main body 50-0, a distance between the phase-pole moving contact 41 and the arc-striking end reaches a minimum spacing, and the phase-pole moving contact 41 will give priority to discharging to the arc-striking end accordingly, so that a strong electric field is generated between the arc-striking member 50 and the arc-striking plate 52 of the arc-extinguishing chamber which, under the action of the airflow and the magnetic field, drives the electric arc to quickly enter the primary arc-extinguishing chamber 94-1 along an inclined plane of the arc-extinguishing member 50, and to be cut by the grid set 49 of the primary arc-extinguishing chamber 94-1. When the phase-pole moving contact 41 is repelled to the breaking position, a gap between the phase-pole moving contact 41 and the arc-striking plate 53 of the secondary arc-extinguishing chamber is minimal, and the electric arc is then transferred to the arc-striking plate 53 of the secondary arc-extinguishing chamber. Because the arc-striking member 50 already has an electric potential, there is still a strong electric field between the arc-striking plate 53 of the secondary arc-extinguishing chamber and the arc-striking member 50 which, under the effect of the airflow and the magnetic field, drives the electric arc to enter the secondary arc-extinguishing chamber 94-2 and to be cut by the grid set 49 of the secondary arc-extinguishing chamber 94-2. The current in the circuit is rapidly limited under the joint action of the primary and secondary arc-extinguishing chambers, such that the electric arc is rapidly extinguished.

7. A side edge of the arc-striking member 50 facing the arc-extinguishing partition plate 51 is provided with an arc-striking member pin that is in plug-in fit with the arc-extinguishing partition plate 51, so as to improve the mounting reliability of the arc-striking member 50.

As shown in FIGS. 15a-15b, a first embodiment of the phase-pole arc-extinguishing system 94 is shown:

in the phase-pole arc-extinguishing system 94 in the first embodiment, the arc-striking member main body 50-0 is of an inverted V-shaped structure, both ends of the arc-striking member main body 50-0 are respectively connected to the primary arc-striking plate 50-1 of the arc-striking member and the secondary striking plate 50-2 of the arc-striking member, and a bend of the inverted V-shaped structure of the arc-striking member main body 50-0 is an arc-striking end.

As shown in FIGS. 16a-16b, a second embodiment of the phase-pole arc-extinguishing system 94 is shown:

in the phase-pole arc-extinguishing system 94 in the second embodiment, the arc-striking member main body 50-0 includes an arc runway structure 50-01 that is respectively connected with the primary arc-striking plate 50-1 of the arc-striking member and the secondary arc-striking plate 50-2 of the arc-striking member; the arc runway structure 50-01 includes an arc running plate 50-010 and an arc running plate connecting portion 50-011 which are arranged side by side at intervals; the respective arc running plates 50-010 are connected end-to-end through the arc running plate connecting portion 50-011; and the arc runway structure is preferably formed into a serpentine line structure. Further, the arc running plates 50-010 are arranged in parallel to each other, and the arc running plate connecting portion 50-011 is preferably of an arc-shaped plate structure.

A U-shaped arc-extinguishing chamber 50-012 is formed between every two adjacent arc running plates 50-010. Open ends of the respective U-shaped arc-extinguishing chambers 50-012 alternately face the electric arc inlets of the primary arc-extinguishing chamber 94-1 and the secondary arc-extinguishing chamber 94-2. In other words, in the U-shaped arc-extinguishing chambers 50-012 which are continuously arranged side by side, wherein an opening of the previous one faces the electric arc inlet of the primary arc-extinguishing chamber 94-1, and an opening of the next one faces the electric arc inlet of the secondary arc-extinguishing chamber 94-2; or an opening of the previous one faces the electric arc inlet of the secondary arc-extinguishing chamber 94-2, and an opening of the next one faces the electric arc inlet of the primary arc-extinguishing chamber 94-1. Further, a plane where the arc running plate 50-010 is located is located is parallel to a plane where the arc-extinguishing grids 490 of the primary arc-extinguishing chamber 94-1 and the secondary arc-extinguishing chamber 94-2 are located.

At least one of the first main body portion 50-0a and the second main body portion 50-0b is provided with the arc runway structure 50-01. Further, the first main body portion 50-0a and the second main body portion 50-0b are both provided with the arc runway structure 50-01. Further, the first main body portion 50-0a and the second main body portion 50-0b are symmetrical structures with each other.

The arc-striking member main body 50-0 further includes a main body cap 50-00 of the inverted V-shaped structure, both ends of the main body cap 50-00 are connected to the first main body portion 50-0a and the second main body portion 50-0b of the arc-striking member main body 50-00 respectively, and a bend in the middle of the main body cap is an arc-striking end. Further, the arc running plate 50-010, connected to the main body cap 50-00, of the arc runway structure 50-01 of the first main body portion 50-0a is a first arc running plate; and the arc running plate 50-010, connected to the main body cap 50-00, of the second main body portion 50-0b is a second arc running plate. The first arc running plate and the second arc running plate are coplanar. One end of the first arc running plate close to the primary arc-extinguishing chamber 94-1 and one end of the second arc running plate close to the secondary arc-extinguishing chamber 94-2 are respectively connected to both ends of the main body cap 50-00.

As another embodiment, one end of the first arc running plate and one end of the second arc running plate, which are opposite, are connected to both ends of the main body cap 50-00 respectively; and an opening of the V-shaped structure of the main body cap 50-00 is opposite to a gap between the first main body portion 50-0a and the second main body portion 50-0b.

The first main body portion 50-0a and the second main body portion 50-0b are respectively connected to the primary arc-striking plate 50-1 of the arc-striking member and the secondary arc-striking plate 50-2 of the arc-striking member through an arc-striking portion transition portion 50-02.

In the arc runway structure 50-01, one ends of the arc running plates 50-010 away from the corresponding arc-extinguishing chamber (the primary arc-extinguishing chamber 94-1 or the secondary arc-extinguishing chamber 94-2) are flush; a spacing between one end of each arc running plate 50-010 close to the corresponding arc-extinguishing chamber and the corresponding arc-extinguishing chamber, from the arc running plate 50-010 of the main body cap 50-00 (or the phase-pole contact system 93) to the arc running plate 50-010 away from the main body cap 50-00 (or the phase-pole contact system 93), gradually decreases. In other words, in the two sets of arc runway structures 50-01, one ends of the arc running plates 50-010 of one set of arc runway structures 50-01 close to the other set of arc runway structures 50-01 are flush; and a spacing between the other end of one end of each arc running plate 50-010 and the corresponding arc-extinguishing chamber gradually decreases from one side of the main body cap 50-00 to the other side. Further, the arc-striking member main body 50-0 integrally forms a pagoda-like structure.

As shown in FIGS. 17a-16b, a third embodiment of the phase-pole arc-extinguishing system 94 is shown, which is different from the second embodiment in that:

in the phase-pole arc-extinguishing system 94 in the third embodiment, a plane where the arc running plate 50-010 of the arc-striking member 50 is located is perpendicular to a plane where the arc-extinguishing grids 490 of the primary arc-extinguishing chamber 94-1 and the secondary arc-extinguishing chamber 94-2 are located; the adjacent two arc running plates 50-010 of the first main body portion 50-0a and the second main body portion 50-0b are central arc running plates; one ends of the two central arc running plates close to the phase-pole contact system 93 are flush, protrude toward a side where the phase-pole contact system 93 is located relative to the rest arc running plates 50-010, and are connected through a arc running plate connecting portion 50-011 which is a central arc running plate connecting portion, the central arc running plate connecting portion is an arc-shaped plate, and the midpoint of the central arc running plate connecting portion is an arc-striking end.

The openings of the respective U-shaped arc-extinguishing cavities 50-012 alternately face a side where the phase-pole contact system 93 is located and a side where the primary arc-striking plate 50-1 of the arc-striking member and the secondary arc-striking plate 50-2 of the arc-striking member are located. In other words, in the U-shaped arc-extinguishing cavities 50-012 that are continuously arranged side by side, the previous one faces a side where the phase-pole contact system 93 is located, and the next one faces a side where the primary arc-striking plate 50-1 of the arc-striking member and the secondary arc-striking plate 50-2 of the arc-striking member are located; or the previous one faces a side where the primary arc-striking plate 50-1 of the arc-striking member and the secondary arc-striking plate 50-2 of the arc-striking member are located, and the next one faces a side where the phase-pole contact system 93 is located.

It should be pointed out that an expansion length of the arc-striking member main body 50-0 determines actual arc-extinguishing and arc-striking effects. With the increase of the length of the arc runway structure 50-01, an arc voltage also increases, so the expansion length of the arc-striking member main body 50-0 should be increased as much as possible in the case of not extending a space allowed.

In the arc-striking member main body 50-1, from the two central arc running plates to both sides, one end of each arc running plate 50-010 close to the phase-pole contact system 93 gradually shifts to a side away from the phase-pole contact system 93. That is, in a direction as shown in FIG. 17a, from the two central arc plates to both sides, the upper end of each arc running plate 50-010 gradually shifts downward.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An operating mechanism of a circuit breaker, comprising a support, and a rocker arm assembly, a jump buckle, a lock buckle in buckling fit with the jump buckle and a re-buckle in limiting fit with the lock buckle which separately are arranged on the support rotatably, a first crank, an energy storage spring, a slide rail fixedly arranged relative to the support, a slider arranged on the slide rail and sliding back and forth along its extension direction, and a first link; wherein one end of the first crank is rotatably arranged on the jump buckle around an eighth center, and another end of the first crank is rotatably connected to one end of the first link and one end of the energy storage spring around an eighteenth center; another end of the first link is rotatably connected to the slider, and another end of the energy storage spring is rotatably connected to the rocker arm assembly; and
the operating mechanism further comprises a phase-pole rotating shaft, an N-pole rotating shaft rotatably arranged around a twenty-second center, a second link, a second crank rotatably arranged around a sixth center, a third link, a third crank and a fourth link, wherein the phase-pole rotating shaft and the third crank are rotatably arranged around a seventh center respectively; one end of the second link is rotatably connected to the slider, and another end of the second link is rotatably connected to the second crank around a nineteenth center to drive the second crank to rotate; one end of the fourth link is rotatably connected to the second crank, and another end of the fourth link is rotatably connected to the N-pole rotating shaft to drive the N-pole rotating shaft to rotate; one end of the third link is rotatably connected to the second crank around the nineteenth center, and another end of the third link is rotatably connected to the third crank to drive the third crank to rotate; and the third crank is in driving connection with the phase-pole rotating shaft to drive the phase-pole rotating shaft to rotate.

2. The operating mechanism of the circuit breaker according to claim 1, wherein
in a vertical direction of the operating mechanism, the rocker arm assembly and the second crank are respectively located at both ends of the operating mechanism, the phase-pole rotating shaft and the N-pole rotating shaft are arranged side by side, the third crank and the phase-pole rotating shaft are arranged close to the rocker arm assembly, and the N-pole rotating shaft is arranged close to the second crank; and
in a horizontal direction of the operating mechanism, the rocker arm assembly and the third crank(s) are arranged side by side, and the third crank, the phase-pole rotating shaft and the N-pole rotating shaft are located on the same side of the operating mechanism.

3. The operating mechanism according to claim 2, wherein the rocker arm assembly is rotatably arranged on the support around a fourth center, and the fourth center, the seventh center, the twenty-second center and the sixth center are sequentially positioned at four vertices of a quadrilateral;
the third link is rotatably connected to the third crank around a twentieth center, and the sixth center, the seventh center, the twentieth center and the nineteenth center are sequentially located at four vertices of a quadrilateral; and the fourth link is rotatably connected to the N-pole rotating shaft around a twenty-third center, and the sixth center, the twenty-second center, the twenty-third center and the twenty-first center are sequentially located at four vertices of a quadrilateral.

4. The operating mechanism of the circuit breaker according to claim 1, wherein the second crank and the third crank are rotatably arranged on the support around the sixth center and the seventh center respectively.

5. The operating mechanism of the circuit breaker according to claim 1, wherein the second crank, the third crank, the N-pole rotating shaft and the phase-pole rotating shaft are arranged to rotate synchronously in the same direction.

6. The operating mechanism of the circuit breaker according to claim 1, wherein the second crank is of a triangular-shaped plate structure, wherein a first apex angle is rotatably arranged around the sixth center, a second apex angle is rotatably connected to the second link and the third link around the nineteenth center respectively, and a third apex angle is rotatably connected to the fourth link around the twenty-first center; and/or
the third crank is of a triangular-shaped plate structure, wherein a first apex angle is rotatably arranged around the seventh center, a second apex angle is rotatably connected to the third link around the twentieth center, and a third apex angle is rotatably connected to the phase-pole rotating shaft around a twenty-fourth center.

7. The operating mechanism of the circuit breaker according to claim 4, wherein the support comprises two support side plates that are oppositely arranged; each support side plate comprises a first side plate portion and a second side plate portion which are connected to each other; in a horizontal direction of the operating mechanism, the first side plate portion and the second side plate portion are arranged side by side; the rocker arm assembly, the jump buckle, the lock buckle, the re-buckle and the second crank are rotatably arranged on the first side plate portion respectively; a V-shaped groove and a slide rail are respectively arranged at both ends of the first side plate portion in a vertical direction of the operating mechanism; the rocker arm assembly is arranged to swing in the V-shaped groove; and the third crank is rotatably arranged on the second side plate portion.

8. The operating mechanism of the circuit breaker according to claim 7, wherein the operating mechanism comprises two sets of second cranks which are symmetrically arranged, two sets of third links which are symmetrically arranged, two sets of third cranks which are symmetrically arranged, two sets of fourth links which are symmetrically arranged, two sets of sliders which are symmetrically arranged, two sets of first links which are symmetrically arranged, two sets of first cranks which are symmetrically arranged, two sets of energy storage springs which are symmetrically arranged, and two sets of slide rails which are symmetrically arranged on the two support side plates respectively; the rocker arm assembly comprises a handle and a rocker arm which are connected fixedly; the rocker arm comprises two rocker arm legs which are arranged oppositely, and the two rocker arm legs are rotatably arranged in the V-shaped grooves of the two support side plates through a fourth shaft respectively; the two sets of first cranks are respectively arranged on both sides of the jump buckle, and one ends of the two sets of first cranks are rotatably connected to the jump buckle through an eighth shaft; an axis of the eighth shaft coincides with the eighth center; another ends of the two sets of first cranks, one ends of the two sets of first links and one ends of two sets of energy storage springs are connected rotatably through an eighteenth shaft; an axis of the eighteenth shaft coincides with the eighteenth center; another ends of the two sets of energy storage springs are connected to a energy storage spring shaft; the energy storage spring shaft is fixedly connected to the two rocker arm legs of the rocker arm respectively; the two sets of sliders are connected through a slider shaft and are respectively arranged on the two sets of slide rails; another ends of the two sets of first links and one ends of the two sets of second links are rotatably connected to the two sets of sliders through the slider shaft respectively; the two sets of second cranks are rotatably arranged on the two support side plates through a sixth shaft respectively; another ends of two sets of second links and one ends of the two sets of third links are rotatably connected to the two sets of second cranks through a nineteenth shaft respectively; an axis of the nineteenth shaft coincides with the nineteenth center; the two sets of third cranks are rotatably arranged on the two support side plates through a seventh shaft; an axis of the seventh shaft coincides with the seventh center; another ends of the two sets of third links are rotatably connected to the two sets of third cranks through a twentieth shaft; an axis of the twentieth shaft coincides with the twentieth center; the two sets of third cranks are respectively in driving connection with the phase-pole rotating shaft through a phase-pole driving shaft; one ends of the two sets of fourth links are rotatably connected to the two sets of second cranks respectively through a twenty-first shaft, and another ends of the two sets of fourth links are rotatably connected to the N-pole rotating shaft respectively through an N-pole driving shaft; an axis of the twenty-first shaft coincides with the twenty-first center; and the two sets of fourth links are located on two axial sides of the N-pole rotating shaft.

9. The operating mechanism of the circuit breaker according to claim 1, wherein when the operating mechanism is in an opened state or a tripped state, the slider is in limiting fit with the slide rail to prevent the slider from sliding, and the slider blocks the first crank from rotating through the first link.

10. The operating mechanism of the circuit breaker according to claim 1, wherein each slide rail is of a groove-like structure or a hole-like structure; and/or the slide rail is arranged on the support.

11. The operating mechanism of the circuit breaker according to claim 1, further comprising a first draw bar and a transmission jump buckle that are in a buckling fit with each other and rotatably arranged respectively, wherein when a short-circuit and/or overload fault occurs in a circuit where the circuit breaker is located, the first draw bar is driven by an external structure to rotate and releases the buckling fit with the transmission jump buckle, and the transmission jump buckle rotates to drive the operating mechanism to trip.

12. The operating mechanism of the circuit breaker according to claim 11, the operating mechanism further comprising a thermomagnetic tripping mechanism, wherein the thermomagnetic tripping mechanism serves as the external structure for the first draw bar; and when a short-circuit and an overload fault occurs in the circuit where circuit breaker is located, the first draw bar is driven to rotate and releases the buckling fit with the transmission jump buckle; and
when the operating mechanism is re-buckled from the tripped-opened state, the rocker arm assembly drives the transmission jump buckle to reset and restore the buckling fit with the first draw bar.

13. The operating mechanism of the circuit breaker according to claim 11, wherein the first draw bar is rotatably arranged on the support around a fifth center, the transmission jump buckle is rotatably arranged on the support around the seventh center, and the first draw bar and the transmission jump buckle are both located between the two support side plates of the support.

14. A circuit breaker, comprising the operating mechanism according to claim 1, and at least one set of breaking unit driven by the operating mechanism to be closed or broken, wherein at least one set of breaking units being phase-pole breaking units for a phase-pole circuit; the rocker arm assembly of the operating mechanism is located at one end of the operating mechanism in a vertical direction of the operating mechanism; each phase-pole breaking unit comprises a phase-pole contact system and a phase-pole arc-extinguishing system which are arranged side by side along the vertical direction of the operating mechanism; the phase-pole contact system comprises a phase-pole rotating shaft mechanism and a phase-pole static contact which are located on one side of the operating mechanism in a horizontal direction of the operating mechanism; the phase-pole rotating shaft mechanism comprises a phase-pole rotating shaft and a phase-pole moving contact arranged on the phase-pole rotating shaft that matches with the phase-pole static contact; the phase-pole arc-extinguishing system comprises a primary arc-extinguishing chamber and a secondary arc-extinguishing chamber whose electric arc inlets are oppositely arranged, an arc-striking member, as well as an arc-striking plate of the primary arc-extinguishing chamber and an arc-striking plate of the secondary arc-extinguishing chamber; the arc-striking member comprises an arc-striking member main body arranged between the electric arc inlets of the primary arc-extinguishing chamber and the secondary arc-extinguishing chamber, and a primary arc-striking plate of the arc-striking member and a secondary arc-striking plate of the arc-striking member which are connected to the arc-striking member main body respectively; the arc-striking member main body is also opposite to a breaking opening formed by the phase-pole moving contact disconnecting with the phase-pole static contact; the primary arc-striking plate of the arc-striking member extends to one side of the primary arc-extinguishing chamber away from the phase contact system, and the secondary arc-striking plate of the arc-striking member extends to one side of the secondary arc-extinguishing chamber away from the phase-pole contact system; the arc-striking plate of the primary arc-extinguishing chamber and the primary arc-striking plate of the arc-striking member are oppositely arranged on both sides of the primary arc-extinguishing chamber respectively; and the arc-striking plate of the secondary arc-extinguishing chamber and the secondary arc-striking plate of the arc-striking member are oppositely arranged on both sides of the secondary arc-extinguishing chamber respectively.

15. The circuit breaker according to claim 14, wherein the circuit breaker comprises a plurality of sets of breaking units arranged side by side, wherein one set of breaking unit is N-pole breaking units;
the N-pole breaking unit comprises an N-pole contact system and an N-pole arc-extinguishing system which are arranged side by side in the horizontal direction of the operating mechanism, and the N-pole contact system comprises an N-pole rotating shaft mechanism and an N-pole static contact that are used cooperatively; the operating mechanism is arranged to span over the N-pole breaking unit along a vertical direction of the operating mechanism; the N-pole rotating shaft mechanism and the phase-pole rotating shaft mechanism are arranged side by side along the vertical direction of the operating mechanism, and rotation axes of the N-pole rotating shaft mechanism and the phase-pole rotating shaft mechanism are parallel; the N-pole rotating shaft mechanism comprises an N-pole rotating shaft and an N-pole moving contact which is arranged on the N-pole rotating shaft that matches with the N-pole static contact;
the operating mechanism further comprises a first draw bar and a transmission jump buckle that are in buckling fit with each other and rotatably arranged respectively; the phase-pole breaking unit further comprises a thermomagnetic tripping mechanism; when an overload or an short-circuit fault occurs in the circuit where the phase-pole breaking unit is located, the thermomagnetic tripping mechanism drives the first draw bar to rotate and release the buckling fit from the transmission jump buckle; the transmission jump buckle rotates and drives the operating mechanism to trip; and
the thermomagnetic tripping mechanism further comprises a second draw bar rotatably arranged; the thermomagnetic tripping mechanisms of the phase-pole breaking units share one second draw bar, and the second draw bar is connected to the first draw bar through a transmission link to drive the first draw bar to rotate; and the transmission jump buckle, the first draw bar and the second draw bar are sequentially arranged on one side of the operating mechanism side by side in the horizontal direction of the operating mechanism.
